(19) United States
(12) Patent Application Publication
(10) Pub. No.: US 2016/0034648 A1
(43) Pub. Date: Feb. 4, 2016

(54) SYSTEM AND METHOD FOR REDUCING CLINICAL VARIATION

(71) Applicant: VERRAS HEALTHCARE INTERNATIONAL, LLC, Palo Alto, CA (US)

(72) Inventors: William C. Mohlenbrock, Carlsbad, CA (US); Marcus Y. Hong, Daly City, CA (US); Timothy M. Breen, San Jose, CA (US)

(21) Appl. No.: 14/813,248

(22) Filed: Jul. 30, 2015

Related U.S. Application Data
(60) Provisional application No. 62/031,150, filed on Jul. 30, 2014.

(51) Int. Cl. G06F 19/00

(52) U.S. Cl. CPC G06F 19/327; G06F 19/3443

(57) ABSTRACT

The present invention is directed to a system and method for enabling physicians and hospitals to objectively reduce clinical and operational variations, which act to improve the quality and cost efficiencies of care. More particularly, the present invention describes medical processes and their enabling technologies that hospitals and physicians may use to objectively identify and replicate physicians and hospital's best clinical and operational practices. The present invention does so by quantifying clinical variation between each physician's best-demonstrated use of specific medical resources and his/her inefficient use of those resources. With his or her own variations quantified, the doctor then compares the variations to those of peer physicians in the hospital who manage similar patients. As healthcare providers use the tools and techniques described in the present invention to reason together and modify their medical and operational practices that reduce the observed variations, their clinical and financial outcomes are objectively improved. These changes in medical and operational practices result in saving millions of dollars per year for each hospital.

### FIELD OF THE INVENTION

The present invention is directed to a system and method for enabling physicians and hospitals to objectively reduce clinical and operational variations which act to improve the quality and cost efficiencies of care. More particularly, the present invention describes medical processes and their enabling technologies that hospitals and physicians use to objectively identify and replicate physicians and hospital's best clinical and operational practices. It does so by quantifying clinical variation between each physician's best-demonstrated use of specific medical resources and his/her inefficient use of those resources. With his/her own variations quantified, the doctor then compares the variations to those of peer physicians in the hospital who manage similar patients. As providers use the tools and techniques described in the present invention to reason together and modify their medical and operational practices that reduce the observed variations, their clinical and financial outcomes are objectively improved. Verras has demonstrated that these changes result in saving millions of dollars per year for each hospital.

### BACKGROUND OF THE INVENTION

The demands for the technologies and techniques contained in this patent have been accumulating for generations. These tools and techniques are the major solution for the Nation's two trillion dollar problems of uncontrolled medical costs and unaccountable quality outcomes. The reason hospitals are incentivized to use these technologies and methods of this invention is the requirement for (hospitals and physicians) to improve performance and increase profitability in the face of declining revenues. This requirement has now become an imperative. Various risk-sharing Accountable Care Act (ACA) models are moving to the main stream, which compel hospitals and their medical staffs to work together as never before. An excellent means of objectively achieving these goals involves reducing variation in clinical and operational processes. After WWII, management gurus such as Deming¹ and Juran² demonstrated excellent quality and efficiency improvements using Reduction In Variation (RIV) techniques in commercial industries. Dr. Don Berwick³ became an early advocate for RIV to achieve similar benefits for healthcare. Consequently, hospitals are now advocating that physicians reduce these results from other industries and use only the appropriate resources to thereby increase efficiencies. But without specific information, how are physicians to know what resource utilization changes will actually improve their efficiencies? They don't know, which generates the compelling need for the technologies and techniques described by this patent.

At this point, it is important to review how hospitals are attempting to reduce clinical variation without the benefit of the technologies and techniques contained in this patent. A majority of hospitals and physicians in the U.S. and Western World have spent a great deal of time and money in an effort to reduce clinical variations using Diagnosis Related Group (DRG)⁷ specific order sets (clinical pathways). The theory behind these efforts is that a single, evidened-based order set will reduce variation and predictably produce outcomes improvements. Another theory behind clinical pathways, particularly among health administrators, is that order set standardizations should be imposed across hospitals and physicians because “it just makes sense that there is a best way for physicians to manage similar diagnoses and procedures”.

These traditional tools prescribe what physicians should order to presumably become more consistent and efficient through their ordering patterns that direct the consumption of diagnostic and treatment resources. Commercial enterprises and hospital clinicians create these lists using evidence-based medical literature and/or what clinicians judge will probably produce the best medical and financial outcomes. The fundamental problem is that none of these methods have objectively demonstrated the ability to consistently quantify and reduce the variations in doctors' usage of diagnostic and treatment resources, which is the first step in reducing variations around their best clinical practices and improving patients' outcomes.

Whether the order sets are purchased from commercial companies, such a Zynx or Cerner, or produced by the hospital's nurses and physicians themselves, the resulting outcomes seldom, measurably improve. In fact, objective information demonstrates there is often a degradation of outcomes for at least two reasons. First, variations are indeed reduced but it is because the outcomes have collapsed around the mean and improvements have ensued. In this case, all patients were managed using the same resources. Second, and even worse, greater numbers of resources are consumed than before the order sets were implemented because the pathways were designed to provide the necessary care for the most acutely ill (sickest) patients. The higher acuity patients were then found to receive adequate management using the appropriate number and types of resources, but the less acutely ill patients consumed far more resources than were clinically appropriate. When carefully scrutinized, these two situations create financial inefficiencies and no improvements or even degradations in quality outcomes.

This patent application details the processes for objectively identifying each resource that physicians utilize to create value, which is the objectively defined, highest quality and most cost efficient outcomes. (Outcomes examples are: Mortality & Morbidity [complications] rates, Readmission rates, Lengths of hospital Stay (LOS), Reductions In Variation [RIV], Patients' Satisfaction and Resource Consumption [Financial] etc.) When clinically reliable and specific information are provided, each hospital and medical staff member is able to reduce unwanted variations and thereby improve clinical and financial outcomes and operational efficiencies. Improvements ensue when physicians and hospital personnel utilize these data to construct Base Order Sets that replicate each doctor's and clinical services' (cardiology, orthopedics etc.) own best practices for future patient management. By re-evaluating these processes every year, the enterprise is able to continuously improve the quality and cost efficiencies of their medical care. The information, generated by the automated tools and processes described in this patent application enable individual physicians and hospitals to move beyond fee-for-service provider payments to value-based healthcare delivery. The results of this transformation from price to value represent the solution to our Nation's problems of uncontrolled healthcare costs and inconsistent quality outcomes.

The federal government implemented Medicare in 1965, which increased access to medical care for senior citizens, but accelerated the progressive rise in health care costs that began in the post WWII era. In an attempted to stem cost increases, Medicare instituted a Prospective Payment System (PPS) in 1983 for hospitalized patients that reimbursed fixed hospital payments on the basis of Diagnosis Related Groups (DRGs). The PPS somewhat slowed the growth of Medicare payments, but hospitals became creative in making up for lost revenues by shifting their costs to individuals and private employers. As a result, our Nation' overall healthcare inflation rates continued to rise unabated.

Congress responded by enacting the 2010 Patient Protection and Affordable Care Act (ACA) in part to control costs and improve medical quality. A powerful provision of the legislation seeks to accomplish these goals by incentivizing integration between hospitals and physicians through bundled payments and the sharing of net saving. Prior to ACA, laws prohibited hospitals and physicians from sharing dollars, even if medical quality was improved. The lifting of the revenue sharing prohibition has encouraged hospitals and doctors to organize and accept risk-bearing contracts for Medicare and other patients. In addition to established cost containment efforts, these contracts have great quality improvement and cost saving potentials. However, these benefits are only achievable if health information systems and quality improvement techniques facilitate providers in defining and producing the highest quality and most efficient care, which is value. Thus far, value-based healthcare deliver has not been a practical reality, as evidenced by the Nation's recalcitrant healthcare inflation rates. The technologies and techniques described by this patent are already changing this calamitous situation.

Since 1965, numerous systems have been developed to assist hospital and physician providers in their attempts to control quality and healthcare costs. These medical outcomes systems have been designed to account for the severity of patients' illnesses because patients with serious illnesses must be expected to die more frequently remain in the hospital longer and consume more resources. The Acuity Index Method* (AIM) is one of a number of systems that use hospitals' medical records data to determine the severity of patients' illnesses based on the interactions of their recorded diagnoses. This is known as the “risk-adjustment” of patient data.

Risk-adjustment systems facilitate the relatively accurate prediction of patients' outcomes, such as mortality, inpatient Lengths of Stay (LOS) and resource consumptions (costs). Other quality metrics are also monitored such as readmissions, infection rates etc. Hospitals also utilize these systems in attempting to assist medical staff members with modifying their practice patterns to achieve greater efficiencies. Physicians' ordering pens control 75%-85% of all inpatient expenditures and their clinical decisions are the basis of the vast majority of medical outcomes. As adept as these quality systems are at predicting patients' outcomes, none of them assist physicians with understanding as to which of their hundreds or thousands diagnostic and treatment processes resulted in their patients' most effective and efficient outcomes over years of practice. The lack of clinical information at the process level, which empowers physicians with this understanding, is the crux of the problem. And, the solution to this problem is the basis of this patent's benefits.

In order to improve hospitals' clinical and financial outcomes, Verras, the developer of the technologies and techniques for this patent, facilitates reductions in variation by supplying physicians with risk-adjusted data with which to decipher the myriad diagnostic and treatment combinations that they deployed to diagnose and treat patients. These combinations or resource usages plus the providers' clinical expertise are collectively referred to as their processes of care. The ability to evaluate what physicians actually do for patients is accomplished by assessing the processes of their care, which cannot be done using outcomes data alone. The limitations imposed by only having outcomes data have been overcome by Verras' patient-level technology that identifies the specific, time-stamped, order-level, hospital resources that are associated with physicians' most and least efficient practices. The results of the treatments are the patients' medical outcomes, such as morbidity and mortality rates as well as financial expenditures. The identification of the more effective and efficient diagnostic and treatment processes is the means by which clinicians are able to replicate and thereby continuously improve future process and outcome performances.

Current tools and techniques have not sufficiently improved quality outcomes or controlled costs. In order to understand the significance of this patent's technologies and techniques, it is necessary to review why previous quality and cost controls have not been successful, in spite of intense scrutiny by public and private payers who seek value (quality and price) for their healthcare dollars.

Determining patients' outcomes (Costs and Lengths Of Stay, [LOS] as examples) is only the first, but important step in quality improvement, and any number of Severity of Illness systems are able to provide medical outcomes^{4,5,6}. However, in order to improve the hospital's efficacies and efficiencies, physicians must also have the information to determine which specific clinical resources and processes produced the observed superior outcomes. The attempts to supply physicians with the information needed to influence their ordering patterns have been in the form of diagnosis-specific orders sets. Order sets are standardized lists of disease specific, diagnostic and treatment resources used by physicians who care for hospitalized patients. They are typically designed by a hospital's medical and nursing staff members to reduce variations in their care processes and thereby improve outcomes. Some order sets (or care pathways) are obtained from other institutions or purchased from commercial companies. Irrespective of their source, order sets represent attempts to influence doctors' clinical practices for greater consistencies and therefore efficiencies. Utilizing the tools and techniques embodied in this patent facilitates the identification of the more effective and efficient diagnostic and treatment processes. It is the means by which clinicians are able to replicate and thereby continuously improve future process and outcome performances. Order sets created in this manner are based on the hospital's hard data, evident-based medical literature plus what doctors, nurses and hospital personnel's previous experiences indicate should be used for certain medical or surgical conditions.

If these traditional attempts had been successful over the past three decades, U.S. healthcare costs would have already been brought under control because virtually every hospital in the Western world uses them in one form or another. But evidence-based literature has inherently wide variations of medically acceptable diagnostic and treatment methods. Moreover, clinicians' impressions as to what should be the most efficient means of managing patients are often based on past experiences of having managed their sickest patients with any given condition. If physicians' impressions become incorporated into the construction of order sets, the less acutely ill patients receive the same comprehensive diagnostic and treatment resources as the very sick individuals. And the majority of empirical evidence demonstrates this phenomenon is the norm. To reiterate for emphasis, such treatment plans invariably have negative financial effects because many patients receive far more expensive tests and treatments than are clinically necessary. Worse yet are the poor quality implications of excessive resources being ordered for patients since every test or treatment has associated, known complications. Resource overutilization is an established major cause of morbidities (complications) and superfluous tests and treatments diminish the quality and efficiencies (value) received by patients and purchasers.

### SUMMARY OF THE INVENTION

Objectively defining and improving healthcare value for patients and purchasers is one of the most important issues in America today. The present invention supplies the missing elements in the highly coveted capability of facilitating physicians and hospitals as they endeavor to objectively improve clinical and operational quality and cost efficiencies. The ability to objectively measure both quality and costs yields the measure healthcare value. The inability to accurately assess medical value was publically lamented by the President of the AMA, Ardis Dee Hoven, MD, in a Apr. 9, 2014 Wall Street Journal article. Contesting the appropriateness of a recent Medicare data release, she stated emphatically, “What we need in this country is data that shows value, and this data isn't going to show value”.

Value is both quality and price as defined by medical outcomes. The ability of health information systems to assess some measures of medical outcomes is now widely known. However, significant improvements in quality and medical cost assessments have not been realized, as previously stated. This is primarily because identifying the root causes of process and outcomes variation and quantifying the economic impact of inefficient processes have not being elucidated.

The most expensive medical device is the physician's ordering pen. With that instrument, they control 75%-85% of all inpatient dollars and basically 100% in the outpatient arena. Clinicians practice medicine. They admit and discharge patients from the hospital and write every order to deploy resources to diagnose and treat patients. Eliminating the root causes of clinical and operational variation in order to objectively define and improve value is why this patent is so important. The technologies and techniques represented in this application is the heretofore-missing ability to accurately correlate each physician's diagnostic and treatment resource deployments (lab, pharmacy, X-ray etc.) with the patients' observed clinical and financial outcomes.

Without this capability, millions of hospital dollars are wasted annually because physicians are unable to identify which of the thousands of their ordered resource combinations were responsible for producing their patients' best-demonstrated outcomes. With Verras' ability to determine each doctor's best practices, as this patent's technologies facilitate, clinicians are able to properly allocate the most resource intense and expensive portion of their best practices by replicating their own efficient resource and process combinations for future patient care.

Measurements: RIV, Quality and Value

The solution to quality improvement and cost containment is for physicians and hospitals to be provisioned with technology and techniques that are able to correlate every physician's diagnostic and treatment resources with the hospital's objectively defined, superior, patient outcomes. The technologies described herein automates these processes by identifying a relatively homogeneous subset of patients with the highest quality, most cost efficient outcomes, then modeling future patients' care around the specific resources used to produce the patients' superior outcomes. As has been stated by many authors and experts³, both clinical and financial outcomes are improved when physicians and hospital personnel reason together to improve processes through reductions in clinical and operational variations. These process improvements are measured using Reductions In Variation (RIV). According to the previously mentioned quality experts, RIV is the essence of quality improvement. Verras has developed technologies and techniques that not only objectively measure individual physician's RIV in clinical and financial processes, but also correlates the most efficient diagnostic and treatment resources with individual physicians' and hospitals' observed medical outcomes.

Measuring and improving medical quality using processes and outcomes metrics are the essential elements of the present invention. Quality is a statistical measure defined by the Institute Of Medicine (IOM) and The Joint Commission (TJC) the references RIV as the “degree to which the process of providing health services increases the probability of desired patient outcomes while reducing the probability of undesired outcomes, given the state of medical knowledge.” Physicians' ordering patterns control the vast majority of inpatient and outpatient clinical decisions and resource consumptions and are therefore the significant drivers of observed clinical quality outcomes.

As previously stated, reduction in variation (RIV) is the essential element of clinical quality improvements of all medical outcomes. Moreover, the quality expert, Don Berwick, states—“Reductions In Variation (RIV) over time are a direct result of providers reasoning together to improve their consistency and the quality of their patients' outcomes.” This patent provides the tools and techniques to improve all metrics of hospitals' quality through RIV, which are then incorporated into Verras patented Medical Value Index. Its unique algorithms assess the improvements of all six major metrics of quality, trended over three (3) years

Using the technologies and techniques described by this patent, doctors can establish sets of medical orders for future patients' diagnoses and treatments that will sustain and continuously improve all the metrics of medical outcomes. The sustained improvements are incorporated into ever improving “Order Sets” that are based on evidence-based literature, plus the doctors' and their hospital personnel's best demonstrated care process and resource consumptions. The objectively defined, high quality, cost efficient outcomes are continuously improved and are specific to each hospital and its medical staff.

Before explaining at least one embodiment of the invention in detail, it is to be understood that the invention is not limited in its application to the details of construction or operation and to the arrangement of the component parts set forth in the following description or illustrated in the following drawings. The invention is capable of other embodiments and of being practiced and carried out in varied and numerous other ways. In addition, it is to be understood that the phraseology and terminology employed herein are for the purpose of description and should not be regarded as limiting.

### Advantages of the Invention

The advantage of this invention is a system and method for enabling physicians and hospitals to objectively reduce clinical and operational variations that improve the quality and cost efficiencies of care.

Another advantage of this invention is the ability for physicians and hospitals to utilize technologies that can facilitate RIV and quality improvements in order for providers to be provisioned with the technology and techniques that are embodied in this patent to correlate every physician's diagnostic and treatment resources with the hospital's objectively defined, superior, patient outcomes. The primary purpose of these activities is to treat patients in the most effective and efficient manner possible. (Without access to these technologies and techniques with which providers can manipulate the clinical data and their operational underpinnings to achieve these ends, patients, purchasers and public officials must expect the same inefficient and unpredictable quality outcome that have plagued the National and International healthcare systems for decades.)

Another advantage of this invention is that it utilizes hospitals' Uniform Hospital Discharge Data Set (UHDDS [medical records data]), enabling the tools and techniques described in this patent to demonstrate to each physician the specific resources he/she used that were most efficient and which reduced the hospital's costs. These types of data are routinely aggregated by hospitals for submission to Medicare and require no manual chart abstractions.

Another advantage of this invention is to accomplish quality and cost efficiency optimization through the use of the UHDDS data to risk-adjusted hospital outcomes data, such as are calculated by the Acuity Index Method (AIM)* or other comparable severity of Illness systems.

Yet another advantage of this patent is the use of Sherlock, which arranges the data provided by AIM for full drill-down analysis, allowing inspection down to the lowest element in a hierarchical arrangement and uses the risk-adjusted hierarchical data to calculate LOS and Cost variations at the patient level. The outputs of these calculations are combined with the third technology, Verras Watson™ that compares and illustrates the test and treatment detail for those patients' with high quality and cost efficient outcomes vs. those with lower quality and inefficiencies.

Another advantage of the system is its ability to create two, acuity adjusted cohorts, one that is more efficient with fewer costs and shorter LOS and another that is less efficient with longer LOS. The Watson system then analyzes each, using drill-down techniques, to their resource consumption Order Levels. Next Acuity-Adjusted, Two Level Order Sets can be created that are necessary to reliably produce continuous quality and cost efficient improvements in medical outcomes of hospitalized patients.

Yet another advantage is that some hospitals have already purchased or created Order Sets and feel they can not abandon them. These technologies and techniques are able to refine these traditional, single-level order sets to eliminate their drawbacks by bifurcating them and increasing their efficiencies. Verras' technologies and techniques are able to further refine the data using risk-adjusted, patient level information that facilitates clinicians' ability to reduce variations that were inadvertently introduced through doctors and hospitals' practice patterns when they used their standard order sets.

Yet another advantage of these technologies and methods is that they unequically demonstrate through objective data, the advantages of Two-level, Base Order Sets. The most effective means of overcoming the inefficiencies of the single-level clinical pathway phenomenon is to risk-adjust patients' data then create bifurcated order sets into Low Acuity and High Acuity clinical pathways for each clinical condition.

Another important advantage of this system is the ability to build the clinical pathways (Base Order Sets) around the hospitals' own data, which is a very important to achieve physicians' acceptance of the data. Culturally, physicians resist the use of order sets that were created by other healthcare institutions.

Another advantage of the system is its ability to demonstrates to physicians the importance of managing patient co-morbid conditions effectively and efficiently. When medical or surgical conditions are managed without a holistic view of each patient's co-morbid conditions as well as his/her Principle Diagnosis, that is, the diagnosis (condition) that brought the patient into the hospital, lack of coordination, tremendous variation and inefficiencies are introduced into the patient's care.

Yet another advantage of this technology and process system is that as the patients transition to the post-acute phase of their hospitalization, such as to a rehabilitation facility or nursing home, the clinical conditions (Co-morbidities), which were recorded during the hospitalization and used to assess their Severity of Illnesses, accompany them to the outpatient facility. Verras' Clinical Variation Solution system ensures that the post-acute care providers have the information to manage these clinical conditions/illnesses based on what was accomplished for the patients prior to discharge from the hospital.

Yet another advantage of this technology and process system is that it overcomes the traditional medical training and literature that perpetuate the standatd, single-condition focus of patient care.

Another advantage is the technologies' ability to trend data over time by risk adjusting a minimum of 3 consecutive years of all-payer, medical records data and time stamping each order to answer specific questions: who wrote the order, when was it ordered, was the care setting appropriate for the clinical condition and were the co-morbid conditions managed in a timely, effective and efficient manner. The traditional, single-condition view of patient care does not answer these questions. Moreover, the inefficiencies become institutionalized if the hospital implements single level order sets or care plans.

Another advantage of this invention is the technologies and best practice techniques abilities to quantify the contributions of each physician's diagnostic and treatment resources to the hospital's clinical and financial outcomes. Hospital have not previously deployed two level order sets because conventional inpatient data do not facilitate physicians' ability to objectively risk-adjust, measure and reduce variation between their best demonstrated performance and their less efficient use of the hospital's costly diagnostic and treatment resources.

Another important advantage of these technologies and methods is their facilitation of dilling down to a hospital Order Level (Line Item) Data. These data types are Laboratory, X-ray, pharmacy and other resources from hospitals' Rev Code Groups. Line item data are the most expensive but not the only resources that determine physicians' guidelines. Nursing, diet, vital sign and many others make up an entire Clinical Pathway. Clinicians and hospital personnel who use the technologies describe in this patent and reason together using risk-adjusted, Order Level, clinical information will reliably produce stable and continuously improving clinical outcomes through reductions in variation.

Another advantage is the ability of the system to document effective resource usage in Lower Acuity Patients and Higher Acuity Patients separately, in order to facilitate the optimization and construction of the Two Level Order Sets. These risk-adjusted patient bifurcations are the most effective means of correcting unrecognized clinical and operation variations that are the basis for inefficient processes. Verras Watson is the technology that quantifies the difference in the use of each hospital resource and makes the information available to clinicians who are constructing the Base Order sets. These clinical pathways are pre-determined, standard sets of medical orders for diagnosing and treating hospitalized patients. (Two Order Sets are formed per DRG, one to be used to treat “Low Acuity” patients [AIM 1, 2, 3] and the other “High Acuity” patients [AIM 4, 5.)

Another advantage of these technologies is to provide doctors with information with which to decipher the myriad diagnostic and treatment resource usage combinations that they deployed to diagnose and treat patients, thereby providing physicians with feedback regarding their most efficacious and most efficient practices.

Another advantage is quantifing the differences in each of the line-item data may initially seem small, but when the cost differences between the inefficiently and efficiently managed cases, are multiplies by the number of Patient Counts, then aggregated for every pharmaceutical, every X-Ray, every Laboratory test, the inefficiencies are in the millions of dollars per year per hospital.

Yet another advantage is in assisting physicians in their understanding of these variations, facilitating the creation of Base Order Sets to facilitate their reductions in variation and quantifying the hospitals' net savings. These abilities may be the difference between profitability and financial insolvency for many hospitals in the near future.

Yet another advantage of this invention is its ability to be used in Ambulatory Surgical Units outside of the traditional hospital setting. However, the Severity of Illness methodology used for these outpatient surgical patients would not be the same as the Acuity Index Method or similar systems, it would be the American Society of Anesthesiologists' Physical Status (ASA PS) classification, but the processes to reduce variation would be the same using this inventions techniques as those used for hospitalized patients.

Another advantage of this invention is that it enables further dissection and analysis of the six, industry standard, major metrics of medical quality. These measures are trended over three years and their outcomes are aggregated by the Medical Value Index, or other similar quality improvement calculations that further breakdown and analyze in greater detail the particulars of patient outcomes. National Hospital Quality Measures (mandated by the federal government), Re-admission rates (also mandated), Morbidity, Mortality, Reduction in Variation [RIV] and Resource consumption (Costs) are the measures incorporated into the MVI.

Another advantage of this invention is that quality (Morbidity, Mortality, Reduction In Variation [RIV] etc.) and resource consumption (Charges or Cost) metrics may be evaluated for each individual physician, each Clinical Service (Cardiology etc.), and the entire healthcare facility.

Yet another advantage of this invention is to its able to use these six major metrics of quality to assess the relative quality and cost efficiency outcomes of each of the clinical services of the hospital e.g. cardiology, orthopedics etc. This is important for a Chief Medical Office or hospital administrator to know which clinical services have been improving over the past year and which ones were degrading or staying the same for purposes of allocating precious resources to one service or another.

Another advantage of the system is the feature that assess quality and efficiencies for each clinical service, because this level of detail is essential for adjudicating what percentage of a hospital's net-saving that should be shared between the hospital and its physicians, as well as between the physicians of the various clinical services of the hospital.

Yet another advantage of the system is its ability to identify not only which specific resources, such as laboratory tests, were deployed and for which clinical condition, but also to identify in which of the hospital units the patients were managed e.g. surgical ICU or coronary care unit. This is important because patients are often managed in a very expensive setting when they could have been managed on the regular medical or surgical floor at much less expense.

And yet another advantage of this invention is flexibility and the ability to demonstrate comparative value among healthcare facilities (hospitals) and physician groups using the Medical Value Index system or any other product that assesses medical quality metrics.

Another advantage of this invention is to objectively demonstrate to physicians that within virtually all Diagnosis Related Groups (DRGs), they invariably manage some of their patients using appropriate resources that objectively produced a cost savings per patient. (However, outcomes data cannot inform the physicians as to which patients they managed efficiently and what resources he/she utilized that saved their hospital's costs.) This invention's tools and techniques identify for physicians which specific resources not only improve their quality outcomes, but which were also responsible for profitability for their hospital's bottom line.

Another advantage of the technologies described herein is they automate the processes of designing two Order Sets per DRG by identifying a relatively homogeneous subset of patients with the highest quality, most cost efficient outcomes, within specified acuity levels. The technologies then model the future patients' care around the specific resources used to produce these homogeneous patients' superior outcomes. With the technologies and techniques described by this patent, doctors can establish sets of medical orders for future patients' diagnoses and treatments that are based on evidence-based literature, plus equally important, on the doctors' and their hospital personnel's best demonstrated care process and resource consumptions. (These highest quality, most cost efficient outcomes, are specific to each hospital and its medical staff.)

Another advantage regarding this patent's technologies ability to create two, risk-adjusted Order Sets is the necessity of coordinating three, disparate technologies, AIM™* (or comparable risk-adjustment tool) and two associated technologies, Verras Sherlock™ and Verras Watson™. Verras Sherlock and Verras Watson technologies are computer-implemented and/or web-based systems specifically designed to target and analyze patient data including their diagnoses and procedures, as well as use of resources to provide a best practices framework for physicians' and facilities' future diagnoses and treatments.

Another advantage is the coordination of the technologies and techniques described in this patent. After the two, risk-adjusted cohorts are defined; Watson further calculates the variation for each test and treatment between the most efficient and less efficient patients for each physician's practice. The technologies and techniques are coordinated to perform these functions so that physicians are able to readily identify which of their patient cohorts have the most cost efficient outcomes and can construct order sets that will eliminate excess variations and resource usage for future patients' treatments. The combination of the technologies and the several techniques that accomplish these benefits can appropriately be described as Physician Directed Best Practice verification reductions.

Another advantage of these technologies and techniques is the ability to assist hospital personnel with reductions in operational variations as well as clinical variations. Clinical reductions in variation create efficiencies, which drive the necessity of operational efficiencies that may involve down- or right-sizing. A simple example might be that by reducing the need for 25% of laboratory tests, the lab department staffing might need to be reduced.

It must be clearly understood at this time, that the preferred embodiment of the invention consists of the physician-directed reductions in clinical variation that many conventional collected healthcare data systems may employ. Some are even derived from the Acuity Index Method as described in U.S. Pat. No. 5,018,067, and the Medical Value Index (MVI) as described in U.S. Pat. No. 8,762,169, or combinations thereof, that will achieve a similar calculation and/or operation. These systems will also be fully covered within the scope of this patent.

With respect to the above description then, it is to be realized that the optimum dimensional relationships for the components of the invention, to include variations in size, materials, shape, form, function, data and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention. Recall that the Acuity Index Method (AIM) is fully disclosed and described in U.S. Pat. No. 5,018,067.

### BRIEF DESCRIPTION OF THE DRAWINGS

The accompanying drawings, which are incorporated in and form a part of this specification, illustrate embodiments of the invention and together with the description, serve to explain the principles of this invention.

The above mentioned and other objects and features of this invention and the manner of attaining them will become apparent, and the invention itself will be best understood by reference to the following description of the embodiment of the invention in conjunction with the accompanying drawings, wherein:

FIG. 1A depicts a flow chart indicating the flow of, use of and dissemination of hospital data, physician's office data, public (MedPAR) data and data from insurance companies into a hospital's Physician-Directed Best Practices quality improvement activities and knowledge base as well as to Medical Value Index algorithms, the outputs being distributed back to the hospital, to Value-Based Healthcare Initiatives (CO-OPs, ACOs, Bundled Payment Models) and to Public Agencies, Consumers and Employers.

FIG. 1B illustrates the relationship between the Verras Sherlock computational model and the Verras Watson analytic model, and the flow of information between the two systems;

FIG. 1C depicts a flow chart indicating the flow of clinical and financial data through the system of the present invention;

FIG. 2 depicts a system chart outlining the physical systems relationships between the medical facility data system, the data center and the end user.

FIG. 3 represents a graphical analysis of the Medical Value Index (MVI) computed using six metrics to calculate a total performance score for an example hospital, in this case, Hospital F. (The higher the hospital's MVI bar, the better the three year trend of the hospital's six outcomes.)

FIG. 4 depicts a four-quadrant graph showing a scatter-gram of patient outcomes compared to internal risk-adjusted norms based on two outcomes, Costs (Y-Axis) and length of stay (LOS) (X-Axis). Each number represents a patient and that patient's Acuity Level with a two-standard deviation oval, meaning 95% of all the patients' costs are within the oval. The position of each patient's acuity level is determined by the two outcomes of each patient. (Above the horizontal line, indicates greater efficiencies compared to the cost norms and to the right of the vertical LOS norms demonstrate shorter LOS than would be anticipated compared to the norms.)

FIG. 5 depicts a four-quadrant graph showing a scatter-gram of the same patient outcomes compared to internal risk-adjusted norms as FIG. 4, based on costs and length of stay, including a line of profitability, which is hospital specific. The patients above the profitability line indicate the hospital received a profit for those patient compared to its expenses. Physicians want to understand where their performances are in relation to the norms and in relation with other providers before and during quality and cost efficiency improvement activities. It is through the identification and repetitious utilization of the most efficient resources that physicians are able to continuously reduce variations that incrementally improve their own and the hospital's outcomes. The patients with the most efficient Cost and LOS outcomes are those located in the right, upper portion of the initial (larger) oval. As physicians reduce variations, using the processes of the best-demonstrated patients (in the right upper portion of the oval), the size of the new, 2 St. Deviation Ovals gets smaller and moves up and to the right (the Oval with dotted lines). Smaller variations (smaller oval) indicate greater consistency in the manner in which patients are being managed. Order sets (clinical pathways) or similar tools are the more common means to accomplish these reductions in variation over time as the doctors standardize the resources they use and the care they give. But improvements only occur when physicians utilize the most effective and efficient resources, in the Right Upper Quadrant (designated as ‘Green’) area. Verras uses the patients and their clinical processes as guides to construct Base Order Sets that increase consistency and efficiencies. When variation is reduced around the most efficient patients' outcomes, the overall mean (Ave.) of the group will move up and to the right (fewer costs and shorter LOS). Without this knowledge, when physicians use common sets of orders the patients' outcomes will simply collapse around the mean (smaller oval), but without improvements.

FIG. 6 depicts a four-quadrant graph showing a scatter-gram of de-identified individual physician's mean outcomes (Costs and LOS), compared to internal risk-adjusted norms, based on Costs and Length Of Stay (LOS). The physicians whose symbols are above the horizontal ($0) line of profitability managed their patients with fewer resources (Costs) than the norm. Those to the right of the vertical line had patients with LOS shorter than the norms. Note that only those physicians' outcomes that are above the “Line of Profitability” are actually profitable for the hospital. (Profitability numbers are specific to each hospital.)

FIG. 7 depicts a four-quadrant graph showing a scatter-gram of patient outcomes compared to internal risk-adjusted norms, based on costs and length of stay, having three large standard deviation ovals and two smaller ovals representing the most efficiently and least efficiently managed patients. The smaller oval in the Rt. Upper Quadrant (Green Cohort) contains patients' outcomes that will be compared to the outcomes in the Lt. Lower Quadrant (designated as Red Cohort). The three large ovals represent the past three years of data with the solid oval being the last year (2013 in this case). This graphically demonstrates for physicians that variations are unchanged over the past three years because the ovals overlap. The most efficiently managed patients are those in the white oval in the upper right hand quadrant (or Green area) and the least efficient are those in the white oval in the lower left-hand quadrant (or Red area).

The data associated with the two patient cohorts (Red and Green) are presented to physicians in group discussions and/or one-on-one trainings sessions. These data are invariably acknowledged by physicians as being objective, transparent and presented in a clear and incisive manner, which makes them comprehensible and easy to use for the clinicians. (Patients that fall outside the two standard deviation oval, to the left and below the Red area, are those with complications, which are also quantified using other methods, (such as enumerating these patients' comorbidities [diagnoses] using the MVI discussed later.) Physicians and Clinical Service's (i.e. cardiology etc.) Order Level data and calculations are used in order to improve clinical and financial outcomes at every level. This is accomplished when the ordering physicians replicate the processes and resources utilized for the most efficiently managed patients i.e. those in the upper, right upper hand portion of the Green area. The variation between the two patient cohorts is thus reduced and quality improvement and cost efficiencies are the result. In order to insure that the mean of the entire cohort moves up and to the right, the targeted variations in the Green area are reduced by 2%, while those in the Red are reduced 6%, for a total of 8% (targeted RIV).

The difference between the outcomes of these two ovals will be measured to determine the % Difference, which will represent the variation between the two cohorts. Each physician will have a calculated Individual Variation Ratio (IVR) for each Revenue Code Rollup and each Order Level, Rev. Code (example—chest X-Ray). This facilitates the ability for a physician to compare his/her efficient (Green) to his/her inefficient outcomes (Red). The average (mean) of all physicians who manage patients of the same type will have their IVRs averaged as the Service Variation Ratio (SVR). This allows each doctor to compare his/her own variations to those of his/her peers.

Example Reports:

Definitions and Explanations:
Individual Variation Ratio (IVR) is defined by % difference between an individual phvsician's most efficient and less efficiently managed cases, within 2 St. Deviations for a Diagnoses or Procedures.
Clinical Service Variation Ratio (SVR) is defined by % difference between the most efficiently and less efficiently managed cases, within 2 St. Deviations for a Diagnoses or Procedures of the average of physicians in a clinical service within the facility (hospital), or doctors who manage similar patients. The smaller the percentage (%) of the IVR and SVR the better, as it indicates greater consistency.
Using Verras Watson, every Service Line for each clinical service may be selected for drilling down to the physician levels e.g. Lab, Pharmacy and X-Ray etc. for all cases or for less severely ill patients (Acuity Index 1, 2, 3) or most acutely ill patients (A.I. 4, 5).
Physicians control the number of units ordered for any resources consumed while the hospital controls the costs. Therefore, variations (percent differences) are calculated for the counts per patient instead of costs per patient because it is more appropriate from the physicians' perspective. Cost variation of each of the resources can also be quantified by the costs per resources utilized times the difference in the number that were ordered (Red v Green).
Potential Non-Related Procedure Reports are recorded for a specific Order Level if the Facility's Clinical Service's Red Count is 1 or > and Green Count is 0. This report highlights resources that were consumed that “Potentially” had marginal indications for deployment, given the fact that the physician had not seen fit to order them for the more efficiently managed cases.

FIG. 8: This report depicts a table illustrating a clinical service report for Lap Cholecystectomy, for all Revenue Codes Rollups (Laboratory, Pharmacy etc.) included in 4 quarter of data through the first quarter of 2013, for a single physician Dr. XYZ, taking in to account all 5 AIM acuity (severity) factors. The table here illustrates how as many as twenty-three (23) Clinical Service Rollup Groups (Left column: Laboratory, Pharmacy and Radiology etc.), are comprised of many Order Level Data (For examples: Complete Blood Count [CBC], Penicillin doses and Chest X-ray etc.). These data from hospitals' charge masters are the data used for the analyses. (Average Counts are used to calculate variation as opposed to Average Costs because physicians control the number of units ordered while the hospital charge master controls the charges or costs.) Each individual physician's most and least efficient resource utilizations are compared in order to demonstrate variations between the two utilization cohorts (Red for the left-hand columns and Green for the right-hand columns) that are usually based on 20 cases each. The IVR ratio is recorded in the second column from the right-most column for physician XYZ. It compares the Ave. Count/Pt. of resources utilized between his/her most and least efficiently managed patients for all Lap. Cholecystectomy Patients.

Note in FIG. 8, the Ave. number of laboratory tests ordered for the 20 Green patients was 11.1 (Ave. Count). The Ave. number ordered for the 20 Red patients was 28.30 per case. The variation between the two numbers yielded an Individual Variation Ratio (IVR) of 153%. The doctor's best demonstrate Ave was the 11.1/case indicating that this doctor (XYZ) was 153% less efficient in the Red patient cohort when compared to his own, best-demonstrated performance in the Laboratory. The doctor (Dr. XYZ's) can then compare his 153% IVR to the Peer Group of Surgeons with Service Variation Ratio (SVR) of 114%, which indicates the Peer Group is more consistent and efficient.

(Any IVR larger than 500% is an outlier and should be used only as an indicator for further investigation. It should not be factored into in a physician's final interpretation of the total difference between IVR and SVR in making definitive decisions concerning inefficiencies.)

Also in FIG. 8, Dr. XYZ's IVRs and SVRs are totaled at the bottom of the column as Total Diff. (This is not a true total of percentages, it is meant to convey a general comparison of the totals.) Dr. XYZ's total % Diff of 629 indicates generally wider variations than the 6 other Gen. Surgeons groups' total % Diff of 571 for all Clinical Service Rev Code Rollup figures for Lap Cholecystectomies. (Therefore, Dr. XYZ is less consistent across the majority of Rev. Code Rollups.)

As Variation is reduced around the clinicians' best-demonstrated outcomes performances (as indicated in the Green cases); the % difference (as recorded as IVR or SVR) will decrease. (In each Clinical Service or Order Level entry, a negative % is recorded as 0%). The information in this level of reporting does not document what specific resources were used in either the Green or Red Areas. Those resources are detailed by specific reports on each of the Rev. Code Groups such as Radiology, which is used here as the FIG. 9 example.

FIG. 9 depicts a table illustrating a clinical service report for Lap Cholecystectomy, for just the radiology department, included in 4 quarters of data through the first quarter of 2013 and in this example, Dr. XYZ data takes into account all 5 AIM acuity (severity) factors. This Verras Watson generated report presents each physician with his/her own Clinical Service and Order Level details for any of the 23, selected Rev. Code Groups, displayed by descending IVR % Diff. Each physician's IVR is compared to the Service's SVR as shown in the far right column. (Radiology is selected for this example. Examining the 20 selected cases of physician XYZ's most efficiently managed cases (Green), 4 of the patients received one (1) “CT ABDOMEN/PELVIS WI CONT”. Each patient having one performed (Ave. Count)=1.00. On the Red side, fourteen (14) Of Dr. XYZ's 20 cases in the Red also had this procedure, however two patients had 2 “CTs ABDOMEN/PELVIS” because the Count/Case=1.14 (not 1.0 per case). This brings up the question as to whether these second procedures were ordered because the patients actually needed 2 of the same procedure during the one hospitalization, or because a consultant did not realize the procedure had been performed and mistakenly ordered a second procedure of the same type—which is a frequent observation. Only the physician can make the determination as to the appropriateness of this duplication. But, this extremely common occurrence in hospitalized patients demonstrates a significant inefficiency that is replicated thousands of time per day in hospital throughout the Nation.

Also note in FIG. 9, there was one patient in the Red area that received a NUCLEAR STRESS/REST SPECT, but none were ordered on any Green patients. (This test is seldom, if ever, indicated for a patient being operated for Lap. Cholecystectomy.) This indicates a significant inefficiency, as do the other tests recorded in the Red column but not the Green. Many of these tests should be ordered in the ambulatory (office) setting, not the hospital. (Calcium Scoring is one of the other such examples) For this reason, these resources are recorded for each physician and for each service as Potential, Non-Indicated Resources (see FIG. 10).

In FIG. 9, physician XYZ's total IVR (29%) is lower than the Clinical Services Ave. (41%) indicating his/her variations for Radiology is less and therefore more consistant than that of the surgery group's Radiology Ave.

FIG. 10 depicts a table illustrating Potential Non-Indicated Resources (PNIR) service report for Lap Cholecystectomy, for just the laboratory department, during 4 quarters of data through the first quarter of 2013, for a single physician Dr. XYZ, taking into account all 5 AIM acuity (severity) factors. The Laboratory tests aggregated here are those that were ordered only on patients in the Red Cohort (left, lower quadrant in the 4 quadrant graph) but were not ordered on patients in the Green Cohort. This suggests the possibility that the ordering clinician did not believe these resources were indicated or they could have been performed in the outpatient arena to conserve resources.

Of physician XYZ's 20 patients, each had an Ave. Count of 2.4 PNIR with total charges of $12,789.00 and total costs of $1,462.78 in the laboratory alone. Some percentage of these PNIRs may not have been indicated for these patients, but this determination is the ordering physician's decision alone. (Total charges and costs are presented to the physicians to give them an idea of the economic ramifications of these potentially, non-indicated resource consumptions.)

FIG. 11 depicts a table illustrating Potential Non-Indicate Resource (PNIR) Savings report for Lap Cholecystectomy, for all Rev Code Rollups and all revenue codes, during 4 quarters of data through the first quarter of 2013, for a single physician Dr. XYZ, taking into account all 5 AIM acuity (severity) factors. Each physician receives this report for all of his/her 23 Clinical Service's Rev Codes. As with the individual Rev Code Groups, these Order Levels have 1 or more entries in the Red cohort with none in the Green. Note the Total Charges, Counts and Costs recorded. Total Costs of $116,171 are only for this one physician and for only 20 of his/her cases. (This doctor actually had more than twice that number of cases.) If the physician is willing to critically evaluate these potentially extraneous resource usages, which they are generally very interested to do, significant costs may be averted during the next year.

This report indicates a potentially very large inefficiency of resource usage based on the large number of tests that the physician apparently thought were not critical or were of questionable indications but that added tremendous expense to the patients' bills. (The physician of record [Dr. XYZ] may, in fact, not have ordered these tests. Nurses or other consulting physicians may have ordered these tests on the doctor's patients.) Each physician receives a Potential Non-indicate Resource (PNIR) report for each or his/her Clinical Service's Rev Code Rollup groups (see FIG. 9). To reiterate the important concept that concerns—physicians, whether or not these resources are actually non-indicated can only be determined by the physician him/herself They are recorded only as “Potential” resources that may have been deployed inappropriately for the patients' clinical cohort being examined. A summary of all the Potential Non-Indicated Resources is recorded for each physician as averages for the number or these PNIRs for each of the Rev. Code groups as well as costs for each.

FIG. 12 depicts a table illustrating a risk-adjusted clinical service report for Lap Cholecystectomy, for all Rev Code Rollups during 4 quarters of data through the first quarter of 2013, for a single physician Dr. XYZ, taking into account only 1, 2, 3 AIM acuity (severity) levels that define a (Low Acuity) patient group. It is designed to identify resource consumption by Acuity Levels, (A.I. 1, 2, 3 are Low Acuity Patients) as opposed to (A.I. 4, 5 are for High Acuity Patients). Note the variations in Dr. XYZ's practice for the various Rev Code Rollups, comparing the Doctor's IVR to his colleagues SVR Ave. for the same resource consumptions. (Example: Laboratory for Dr. XYZ's IVR 163% vs. his peer's SVR Ave. of 113% indicating the peer group is more consistent and efficient than Dr. XYZ.) Also note the Total % Difference (% Diff) for the Peer Group is 889% for the Lower Acuity Cohort of patients (AIM: 1, 2, and 3). A single order set should not be constructed for a single DRG because the patients in A.I.s 1 thru 5 are too dissimilar. The Acuity Index 1, 2 and 3 patients are relatively homogeneous as are the A.I. 4 and 5 (see FIG. 13 below) patients. Therefore, two orders sets should be designed for each DRG—one for the lower acuity patients and one for the high acuity patients. When these two cohorts are evaluated separately the issue as to which cases are more efficiently managed can be determined by comparing the Total % Diff.

FIG. 13 depicts a table illustrating a risk-adjusted clinical service report for Lap Cholecystectomy, for all Rev Code Rollups, during the 4 quarters of data through the first quarter of 2013, for a single physician Dr. XYZ, taking into account only AIM 4, 5 acuity (severity) factors for a (High Acuity) patient group. Note at the bottom of the report, the Total % Diff. for the Peer Group is 439%. This indicates that in the High Acuity Patient Cohort, the peer group of physicians is more consistent and efficient than Dr. XYZ Total of 547%.

Comparing outcomes from FIG. 12 to those of FIG. 13, of even greater clinical significance is the fact that Peer group (Total % Diff. of SVR) is more efficient with smaller variation 439% in the High Acuity Patient Cohort (see FIG. 13) than they are in the Low Acuity Cohort (889%) noted in FIG. 12. This means these doctors treat their sickest patients efficiently but over-utilize (waste) resources on their less acuity ill patients. This is an extremely common finding in all hospitals because physicians concentrate on the single diagnosis that brought the patient into the hospital and make sure they use sufficient resources for the sickest patients with that diagnosis. But they use the same number of tests and treatments on the patients that really do not need them (low acuity patients). This is not only inefficient; it is poor quality since every test and treatment that physicians use has a down-side complication rate.

FIG. 14 depicts a table illustrating a Level 1 service report for Lap Cholecystectomy, for all Rev Code Rollups and physician, during the 4 quarters of data through the first quarter of 2013, but for only A.I. 1, 2, 3 (Low Acuity) patients. Further, this report demonstrates how many of the Green patients received resources from each of Ref Cod Rollups. (Example—17 of the 17 patients on the Green side received Pharmaceutical medications.) When physicians utilize the technologies and techniques described in this patent application, this level of data analysis will target which resources should be used in an effective and efficient low acuity order set. The Low Acuity Patient Cohort (AIM 1, 2, 3) will have an Order Set constructed for future patient management using only the resources from the Green (most efficient) data seen on the right side of the table. Note the 17 Pats. had ordered for them an Ave. of 29.53 pharmaceuticals ordered for their care. The specific pharmaceuticals that will be included in the order set will be taken from the specific Low Acuity data in FIG. 16. This Order Level information is the knowledge the doctors need to examine at the next level of detail in the pharmacy area for which specific medications and their dosages that should be included in the Low Acuity order set.

FIG. 15 depicts a table illustrating a Level 1, risk-adjusted, service report for Lap Cholecystectomy, during the 4 quarters of data through the first quarter of 2013, taking into account AIM acuity (severity) levels 4 and 5 only. This level of data analysis is used when targeting which resources should be used in an effective and efficient high acuity order set. This High Acuity Patient Cohort (AIM 4, 5) will have an Order Set constructed for future patient management using only the resources from the Green (most efficient) data. The specific pharmaceuticals, their dosages and number of tables or injections that will be included in the order set will be taken only from the High Acuity data of the Laboratory, Pharmacy, and Radiology etc.

FIG. 16 depicts a table illustrating a risk-adjusted, clinical service report for Lap Cholecystectomy, for the pharmacy, during the 4 quarters of data through the first quarter of 2013. This level of data analysis is used when identifying which resources should be used in an effective and efficient low acuity order set—AIM acuity (severity) factors 1, 2 and 3 only. These are the data needed to create the pharmacy portion of an efficient low acuity Order Set. Note the specific, Order Level pharmaceutics that will be used in the Order Set for the Low Acuity patients, such as the ZOFRAN-INJ PER 1 MG, Avg. used in 17 Green Pats was 1.82. For Red cases, the Ave. was 2.35. This seemingly small difference translates to millions of dollars per year of inefficiencies across all pharmaceuticals, all labs, all X-Rays etc. within the hospital.

FIG. 17 depicts a table illustrating a clinical service report for Lap Cholecystectomy, for the pharmacy department, during the 4 quarters of data through the first quarter of 2013, This level of data analysis is used when creating the pharmacy portion of an efficient high acuity Order Set and identifying which resources should be used in the order set —AIM Acuity (severity) levels 4 and 5 only. Note the specific, Order Level pharmaceutics that will be used in the Order Set for the high Acuity patients, such as the ZOFRAN-INJ PER 1 MG, Avg used in 9 Pats was 1.56. In the Red group 2 additional does were used per patient (3.67 Ave. Count). The Ave. Cost for each patient was $344.60.

FIG. 18 depicts a table illustrating a clinical service report for Lap Cholecystectomy, for the laboratory clinical department, during the 4 quarters of data through the first quarter of 2013, severity levels 1, 2, 3 only. This level of data analysis is used when creating the laboratory portion of an efficient low acuity Order Set and identifying which Lab resources should be used in the order set—AIM acuity (severity) levels 1, 2 and 3 only. Note the specific, Order Level Laboratory test that will be used in the Order Set for the Low Acuity patients, 1, 2, and 3 only. The specific Laboratory Order Levels (CBC with differential) that will be used for the Order Set is the 1.36 Avg. Count in 14 of the 17 Green Patients, not the inefficient 1.67 Ave Count on the Red cases. This level of laboratory tests will be incorporated into the clinical pathway (order set) for these Low Acuity patients' future medical management.

FIG. 19 depicts a table illustrating a clinical service report for Lap Cholecystectomy, for the laboratory clinical department, during the 4 quarters of data through the first quarter of 2013 for AI Levels 4, 5. This level of data analysis is used when identifying which Lab resources should be used in creating an effective and efficient high acuity order set —AIM acuity (severity) factors 4 and 5 only. The specific Laboratory Order Level (Lipase) was used 1.44 Avg. Count in 9 of the 12 Green Patients. This will be incorporated into the clinical pathway (order set) for these High Acuity patients' future medical management.

FIG. 20 depicts a table illustrating a Clinical Service Report for Lap Cholecystectomy, for medical/surgical supplies, during the 4 quarters of data through the first quarter of 2013. This level of data analysis is used when creating the Medical/Surgical portion of an efficient low acuity Order Set and identifying which Medical/Surgical resources should be used the set—AIM acuity (severity) factors 1, 2 and 3 only. The specific Med/Surg. Order Levels (VICRYL SUTURE) was used 1.65 Avg. Count in 17 of the 17 Green Patients. This will be incorporated into the clinical pathway (order set) for these Low Acuity patients' future medical management.

FIG. 21 depicts a table illustrating a clinical service report for Lap Cholecystectomy, for medical/surgical supplies, during the 4 quarters of data through the first quarter of 2013. This level of data analysis is used when creating the Medical/Surgical portion of an efficient high acuity Order Set and identifying which Medical/Surgical resources should be used in the set. Note the specific, Order Level Med./Surg. resources that will be used in the Order Set, taking into account AIM acuity (severity) factors 4, 5 only. The specific Med/Surg. Order Levels (ETHICON BLADELESS TROCHAR) Avg. Count 1.08 in 12 of the 12 Green Patients. This will be incorporated into the clinical pathway (order set) for these High Acuity patients' future medical management.

### DETAILED DESCRIPTION OF THE PREFERRED EMBODIMENTS

For a fuller understanding of the nature and objects of the invention, reference should be addressed to the importance of improving medical outcomes through the use of data driven, Two Level Order Sets. First, why have two level methods of standardizing physicians ordering patterns not been deployed in the past? Second, how does this invention facilitate their construction for each hospital?

The first question is why have two level order sets not previously been used? The answer is the lack of risk-adjusted and quantified efficiency data such as that proved by this invention. This ability to create the two levels can only be addressed with using technology that risks adjusts the data in concert with other technology that is able to stratify the information into levels of efficiency. A majority of hospitals and physicians have spent a great deal of time and money in an effort to reduce clinical variations using order sets from various sources because they have no internally derived, risk-adjusted, and efficiency stratified information. Whether the order sets are purchased from commercial companies, or produced by the nurses and physicians themselves, the resulting outcomes seldom demonstrate improvements because the pathways were not created using their own best practices. In fact, their results most often show no change or a worsening of outcomes.

Experience indicates that when a single order set is used for any cohort of medical or surgical patients, one of two results are noted after a year of implementation using these traditional types of order sets. Either variation is reduced by outcomes that have collapsed around the mean with no change in outcomes, or there are greater resources consumed than before the order sets were implemented. Both results lead to less efficient outcomes than before the implementation of single-level order sets were implemented. This is because these types of clinical pathways were designed to care for the most acutely ill (sickest) patients. The higher acuity patients are thereby relatively well managed, but the less acutely ill patients have many more resources ordered for them than are appropriate. This is often compounded by the fact that in most hospitals, lesser acutely ill patients are the majority, therefore even greater inefficiencies ensue.

There is also a misconception by academics and health administrators that order set standardizations should be imposed across hospitals and physicians because there is a “best way to practice for all diagnoses and procedures”. The technologies embodied in this patent are the only means of objectively demonstrate why this concept is inaccurate. When data, such as are presented here, demonstrate through comparative hospital data that this contention is not supported, (which is the reason for being cautious about using order sets across multiple hospitals). Unlike manufacturing where inputs (metal and plastics) and units of production (workers and their processes) can be standardized, patient populations are very disparate inputs and the units of production (physicians, nurses and hospital administrations) are equally dissimilar.

However, within each hospital, patient populations are more homogeneous than those of an entire city or state and over a year's time, each physician manages patients throughout that hospital population. Physician comparisons are therefore reasonable. This is substantiated by the risk-adjustment and Sherlock technologies that stratify the patients by severity levels and efficiencies. When compared to other facilities, each hospital's patients are demonstrated to be relatively homogeneous. Moreover, clinicians and hospital personnel who work and reason together can use risk-adjusted, clinical information and produce relatively stable and continuously improving clinical outcomes through reductions in variation.

The technologies describe in this patent, use each hospital's own data. This plays into another important cultural issue to consider in today's medical environment is physicians' reticence to use order sets that were not produced using their own data and by their hospital's clinical colleagues. Experience indicates that comparing each physician to him or herself and then the comparing the physician to his/her peers is well received, as opposed to comparisons to external norms or hospitals.

For all of these reasons, these technologies and techniques are critical because it is important to physicians to document efficiencies in Lower Acuity Patients and Higher Acuity Patients separately, in order to facilitate the construction of Two Level Order Sets using each hospital's own data. These risk-adjusted patient categorizations invariably demonstrated previously unrecognized clinical inefficiencies and questions of why the inefficiencies persist. Such as, physicians often harbor a misperception of the data that less sick (lower acuity) patients are those found in the Rt. Upper Quadrant (Green), while the sicker (High Acuity) patients are, most likely, in the Red (Left Lower Quadrant). Verras' data dispels this notion by demonstrating the distribution of the lower and higher acuity patients occur in both the Red (inefficient) and Green (efficient) areas of the 4 quadrant graphs. Once the hospital and clinicians have the types of specific risk-adjusted data produced by this invention, these misunderstanding are dispelled and any inefficiency they cause are easily rectified. The doctors are then prepared to move on to the next issue, which is the ability to build risk-adjusted clinical pathways (base order sets) without obtaining pathways that are externally generated.

Base Order Sets are only the resource frameworks used by physicians and hospital clinicians to construct their hospital's final order sets. Other processes, such as diets, vital sign recording requencies etc., must be added to these base orders. The laboatory, X-ray etc. resources described by these techniques are the most expensive, which explains the economic benefits of these technologies. But, they are not the only resources that determine physicians' guidelines for use during the subsequent 6 or 12 months. After that time, the data should be re-run and this entire process re-evaluated to create a new and improved order set. In this manner, continuous quality and cost efficiency improvements will be ensured. This is in keeping with all quality improvement initiatives advocates by medical and non-medical experts.

For a fuller understanding of the nature and objects of the invention, reference should be had to the following detailed description taken in conjunction with the accompanying drawings wherein similar parts of the invention are identified by like reference numerals. The accompanying drawings, which are incorporated in and form a part of this specification, illustrate embodiments of the invention and together with the description, serve to explain the principals of this invention.

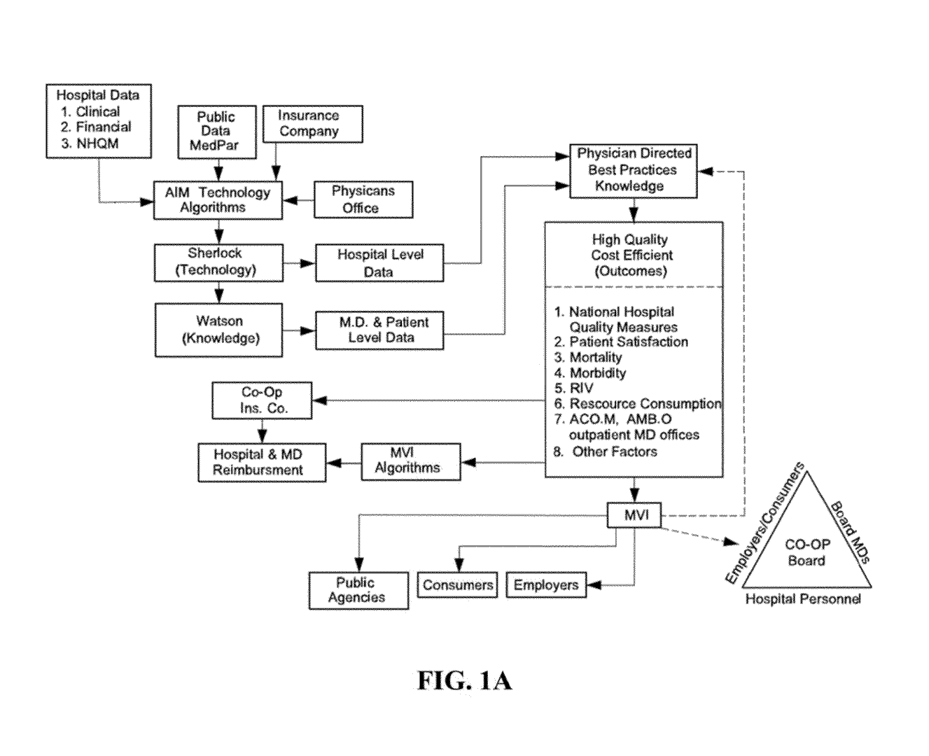

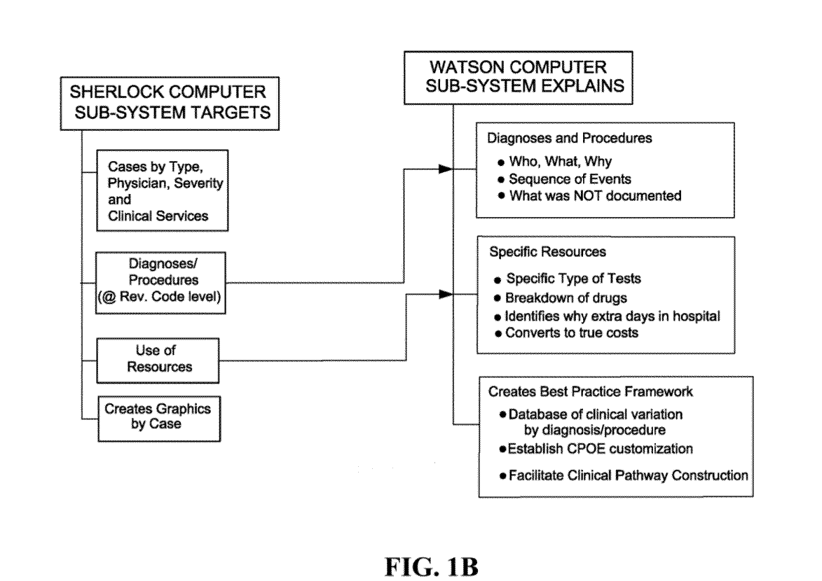

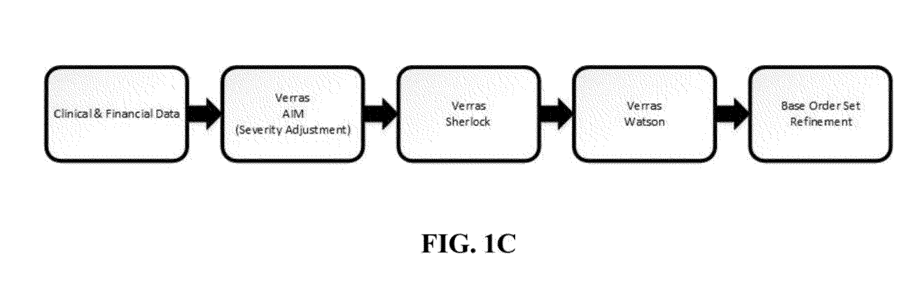

Referring now to the drawings, wherein similar parts are identified by like reference numerals, FIG. 1A shows a flow chart of data leading to the calculation of a Medical Value Index (MVI) also known previously as an Index of Quality Improvement (IQI), but from here forth simply referred to as MVI, and the pathways of use of that MVI. The reduction in clinical variation as described in this patent are the means by which clinicians are able to reduce clinical and operational variation of care that improve clinical and financial outcomes. MVI is the unique system for quantifying and recording the improvements in each of these quality measures for the purpose of objectively demonstrating whether or not each hospital and its clinical departments have improved their outcomes of care. The MVI is able to correlate all changes in the major metrics of quality and costs that are trended over a three year period and answer the much sought after question as to the definition of hospital “value”. And value is defined as healthcare quality and costs. MVI is a quantified measure of value much like that seen for comparing publically traded companies and another for commercial products of all types.

The MVI's data is originally sourced from hospital records or public data like MedPAR (Medicare). The data is fed to Acuity Index Method (AIM) technology algorithms and sent to Sherlock for conversion into hospital level data. Data from Sherlock is also sent to Watson knowledge system for transference into MD and patient level data. Both hospital level data and MD and patient level data are used to facilitate physicians' and hospital personnel education to reduce variation and improve all metrics of quality. Hospital or Medicare (MedPAR) data are used in calculating a Medical Value Index (MVI) score if specific hospital data is not available. The technologies and techniques described by this patent are the means by which physicians are able to reduce clinical variations in order to improve the clinical metrics that make up the bulk of the MVI. (Mortality, Morbidity, RIV, Resource Consumption and many of the optional measures.)

In FIG. 1A, seven (7) metrics are shown: 1. National Hospital Quality Measures (NHQM) & Patient Satisfaction; 2. ReAdmission 3. Mortality; 4. Morbidity; 5. Reductions in Variation (RIV); 6. Resource consumption; and Optional: 7. Additional metrics such as: Accountable Care Measures (ACOM), or ambulatory outcomes (AMBO) from outpatient MD offices. A more typical arrangement of metrics is to combine metrics 1 and 2 into a compound metric 1 called Quality Measures & Patient Satisfaction (QMPS). Furthermore, a new metric titled Re-Admission (RADM) is installed as metric 2. One or more additional/Optional factors, represented by metric 8 can also be used in the calculation of MVI. The metrics within the MVI are modular and may be tailored to fit the hospital or provider enterprise. Once an MVI is determined, it is sent to public agencies, consumer, employers and optionally Consumer Oriented and Operated Plans (CO-OPs), and may be sent back to the physician directed best practices knowledge base for evaluation and planning for future improvements. CO-OPs may use the MVI information through their CO-OP Board and disseminated to employers/consumers, board MDs and hospital personnel. (CO-OPs and Bundled-Payments are a part of the Affordable Care Act of 2010.)

As illustrated in FIG. 1A the present invention is a system for healthcare performance measurement and equitable provider reimbursement comprising the elements of: (a) gather medical information from hospitalized patients' charts, hospital medical records department data, insurance company data, and physician's office data; (b) aggregate the gathered data and calculating the following quality metrics: National Hospital Quality Measures (NHQM) and patient satisfaction, both mandated by Centers for Medicare and Medicaid Services (CMS), morbidity, mortality. Reduction In Variation (RIV), resource consumption; (c) calculate a Medical Value Index (MVI) for each hospital's clinical services (Cardiology etc.) and the overall hospital provider; (d) generate value sharing computations and calculate overall net savings; and (e) distribute said net savings to physicians, hospitals, CO-OPs, bundled payment, hospital initiatives and insurers in the form of bonuses or reimbursements.

FIG. 1B illustrates the characteristics of and relationships between Sherlock and Watson, and in particular it illustrates the data flow between the two systems. AIM technology algorithms (as seen in FIG. 1A) are employed to aggregate data gathered from medical information from hospital patients charts data, hospital medical records department data, insurance company data, and physician's office data, prior to providing the resulting information to a Sherlock sub-system. The Sherlock sub-system arranges the data for full drill-down analysis, allowing inspection down to the lowest element in a hierarchical arrangement.

Sherlock sub-system aggregated data is further analyzed by a Watson sub-system which explains diagnoses and procedures and resource expenditures originated by whom (ordering clinician), what and why, sequence of events and what was not documented (co-morbidities), explains specific resources by specific type of tests, breakdown of drugs, identifies why extra days were spent in hospital, and converts to true costs, and create a best practices framework by database of clinical variation by diagnosis and procedure, facilitates the establishment of a computerized physician order entry (CPOE) customization and facilitates Two Level, Risk-Adjusted, clinical pathway (Order Set) construction. At the revenue code level —every billed item in a hospital has a revenue code. For example a Chest X-ray is 320. Sherlock has the capability of informing the ordering and consulting clinicians that during a specific hospital stay, there were 10 chest rays using these codes. However, depending on the hospital's HIS system, the revenue code level may not be able tell the specific type of chest X-ray nor when it was ordered and who ordered it, unless the hospital's HIS supports Verras' ability to time assign the ordering physician and stamp every order. (Most sophisticated hospitals either have these capabilities are they are working on acquiring them.)

The Watson sub-system provides an alternate and deeper analysis to the data clues provided by the Sherlock sub-system. Watson's Chart Audit tools use the Revenue Codes and other data targeted by Sherlock to discover the basis of why, who, when these order were written. CPOE is short for Computerized Physician Order Entry used in a growing number of hospitals. Now that all hospitals are moving toward the Electronic Health Record (EHR or EMR), a physician must bring up a screen and decide what orders are required rather than just pull the chart and write them out. Having the technologies described in this patent will ensure the physicians that they are not randomly selecting the resource without knowing the economic and quality implications of their selections from the CPOE lists.

In order to expedite this process, templates are built by diagnosis to list the most appropriate or likely test based on diagnosis, and more importantly, on the severity of the patients' illnesses. Watson will use the individual physician's actual order variations as well as that of the physicians who manage the same types or patients, identifies their most efficient, best practices and customize these templates. The value here is that by customizing (shortening) this list it improves compliance with the CPOE and prompts the physician to reconsider his previously inefficient ordering pattern to minimize over-ordering.

FIG. 1C depicts a flow chart indicating the flow of clinical and financial data through the system of the present invention. Clinical and financial data are gathered and collected from various healthcare facility databases, and through Verras' AIM, the data undergo a severity adjustment analysis, before being passed on to Verras Sherlock and Verras Watson computer-implemented web based computer programs (see FIG. 1B), for base order refinement. AIM is fully described and disclosed in U.S. Pat. No. 5,018,067, and that patent is incorporated herein in its entirety.

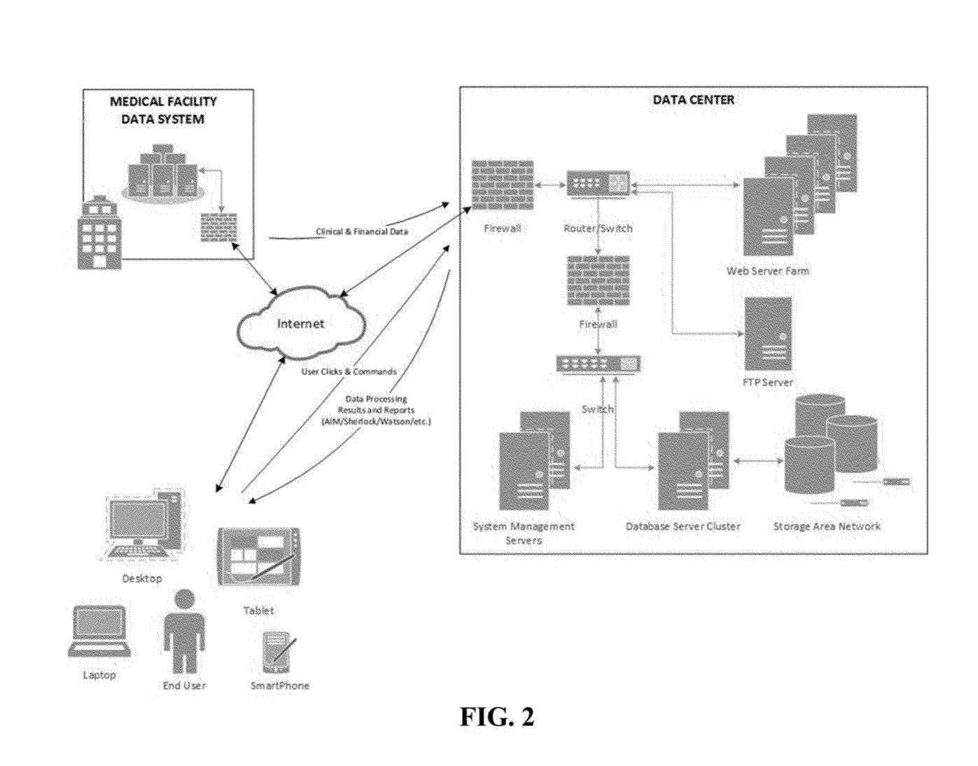

FIG. 2 depicts a system chart outlining the physical systems relationships between the medical facility data system, the data center and the end user. This system chart also indicates the flow of information throughout the physical system. Clinical and financial data flow from the medical facility system to the data center, by direct means, or via the Internet. The data center processes this information and sends detailed analysis reports to the end user wherein said end user may access such reports and analyses via their desktop computer, laptop computer, tablet smartphone, or any like device.

Furthermore, FIG. 2 depicts a physical system infrastructure essential to the construction and operation of the present invention. The present invention is not a stand-alone abstract idea, but consists of technologies and a method which transforms clinical and financial data into reports that are useful to practicing physicians, all deployed through a physical network of machines, including computers, system management servers, database server clusters, storage area networks, storage memory, firewalls, router switches, FTP servers and web server farms, all of which physical infrastructure is essential to the operation of the system that makes up the present invention, and without which the invention could not possibly be practiced.

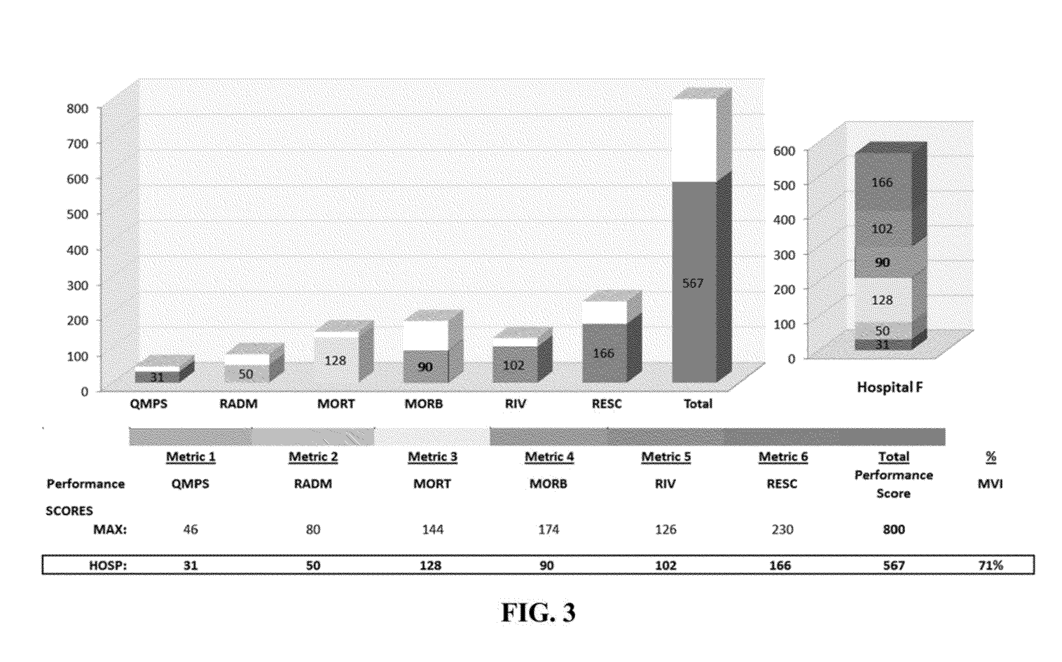

FIG. 3 represents a graphical analysis of the Medical Value Index (MVI) computed using six metrics to calculate a total performance score for an example hospital, in this case, Hospital F. N.B. The present invention and its relation to Verras' Medical Value Index (MVI) is described here in order to demonstrate how the process improvements described in the present invention are the basis of continuous quality and cost efficiency improvements in the clinical outcomes that constitute the metrics of the MVI. MVI is fully described and disclosed in U.S. Pat. No. 8,762,169, and that patent is incorporated herein in its entirety.

The MVI technology is a means by which healthcare providers and purchasers can assess the relative quality and cost efficiencies of hospitals' performances. The index uses six industry-standard outcomes of clinical quality and cost efficiencies for inpatient care. An optional seventh measure may be used for additional quality components, such as Medicare's 33 measures of quality for an Accountable Care Organization (ACO) or other clinically specific metrics such as the National Joint Replacement Registry (NJ RR) for orthopedics. If the data are available, all outcomes are trended over a three-year period to maximize accuracy.

The clinical and financial outcomes that are improved through Reductions In Variation (RIV) by the technologies and techniques of this patent and are documented at the hospital level by Verras' MVI. Through the use of these techniques, each physician's performance is inextricably tied to the overall performance of the hospital in which he/she practices. Not only can private and public purchasers as well as patients observe the quality and cost efficiencies of hospitals, but also physicians' outcomes improvements can be rewarded through Value-base reimbursements at the overall hospital level or for each clinical service (orthopedics etc.).

Hospitals and physicians use the MVI for quality improvements and the objective distribution of dollars between the hospital and its physicians' clinical services. This is extremely important as providers begin to share net-savings under federally sanctioned value-based payment models. These include Global Payments arrangements, such as ACOs, ACEs and Consumer Operated and Oriented Plans (CO-OPs) as well as the four types of Episode of Care or Bundled Payment Care Improvement Models.

Private and public purchasers use the MVI to assess the relative quality and cost efficiencies of regional hospitals and their clinicians, using public State Databases or MedPAR data. (MedPAR data is publically available, contains Medicare data from over 6000 hospitals but is two years in arrears.) Self-insured employers seeking contracting arrangements with specific, effective and efficient hospitals and provider groups have the incentives to request these hospitals' All-Payer data, which includes all their patients' current information.

The MVI creates a positive score for each of the six (or more) measures. The higher each portion of the metrics, which make up the MVI bar graph, the greater the indicated 3 year improvements in quality and efficiencies. Example—a low mortality rate is desirable and is therefore assigned a higher score based on the hospital's actual mortality rate. The same is true for Morbidity rates. However, the several scores that make up both the National Hospital Quality Measures and the 33 ACO measures are positive numbers and therefore no positive conversions are necessary. They are recorded as their actual levels of performance.

The MVI7 is created using a hospital's All-Payer data plus, for example, the 33 ACO, or other previously mentioned, optional metrics. These data are used by hospitals for Physicians-Directed, Best Practice Improvements and are typically updated on a quarterly basis. The six metric MVI is used in this example. All measures are derived from each hospital's medical records and IT departments and are trended over a three (3) year period to give the most comprehensive assessment of a hospital's quality and financial outcomes.

The Six Inpatient Metrics of Quality that Constitute the Medical Value Index (MVI) Plus the Location for Other Optional Metrics:
1. National Hospital Quality Measures plus HCAHPS ‘Patient Satisfaction’ (QMPS)—both are reported to the Center for Medicare and Medicaid Services (CMS) and JCAHO
2. Hospital Readmission Rate (ReAdt)—as reported to CMS
3. Mortality Rates (Mort.)—nine (9) different hospital mortality metrics are trended for 3 years.
4. Morbidity Rates (Morb.)—measured for the hospital's 5 MS-DRGs within each of the five clinical services that have the greatest resource intensity (largest numbers of charges).
5. Reductions in Variation (RIV)—5 MS-DRGs for the five most resource intense services.
6. Resource Consumption (Res. Con.)—charge inflation rates trended over a three-year period.
7. Optional Metrics (ACO, CJRR etc.)—for designated ACOs, CA Joint Replacement Registry, or any other quality metrics defined by providers.

The six MVI metrics are stacked to create the MVI bar graph and score: (Example FIG. 3, Bar Graph on Right, score—567/800). The height of each clinical component indicates the relative contribution to the overall score and the degree to which the indicator was improved over three years. The 6 metric MVI utilizes an 800-point scoring method while the 7 or more metrics MVI uses a 1000-point total. The metrics have different weighting factors based on experiential evidence as to which metrics are the most predictive of actual clinical quality and cost efficiency improvements.

The Medical Value Index was developed in order to demonstrate quality and efficiency improvement outcomes in a transparent and easily understood manner for all stakeholders. Hospitals and physicians who participate in bundled payment programs use the MVI to objectively measure their quality and cost efficiency outcomes as well as distribute net-saving among providers. MVI is the only technology that objectively quantifies each physician's best-demonstrated clinical practices in order to continuously improve their own outcomes as well as those of their entire enterprise. The technologies and techniques embodied in this patent are the only tools for objectively demonstrating quality and cost efficiency improvements as well as facilitating physicians' abilities to improve them.

Purchasers use the MVI as an excellent means of comparing the efficacies and efficiencies of competing hospitals and other provider enterprises in order to select the highest quality, most cost efficient provider groups and create value-based healthcare purchasing in their communities.

In summary, Verras' patented MVI is a proven tool and technique, which accurately records providers who consistently achieves high quality, cost efficient clinical and financial outcomes by reducing individual physicians' variations in care processes, which objectively improves patients' outcomes. The results are unprecedented cost saving and quality improvements for inpatient care that benefit all stakeholders. MVI is the means of documenting the specific clinical services within each hospital and/or which hospitals when compared to others are objectively improving over time. It is recommended that MVI data be employed in the operation of the present invention to derive optimal results, however, other MVI-like data systems may also be used to provide similar result.

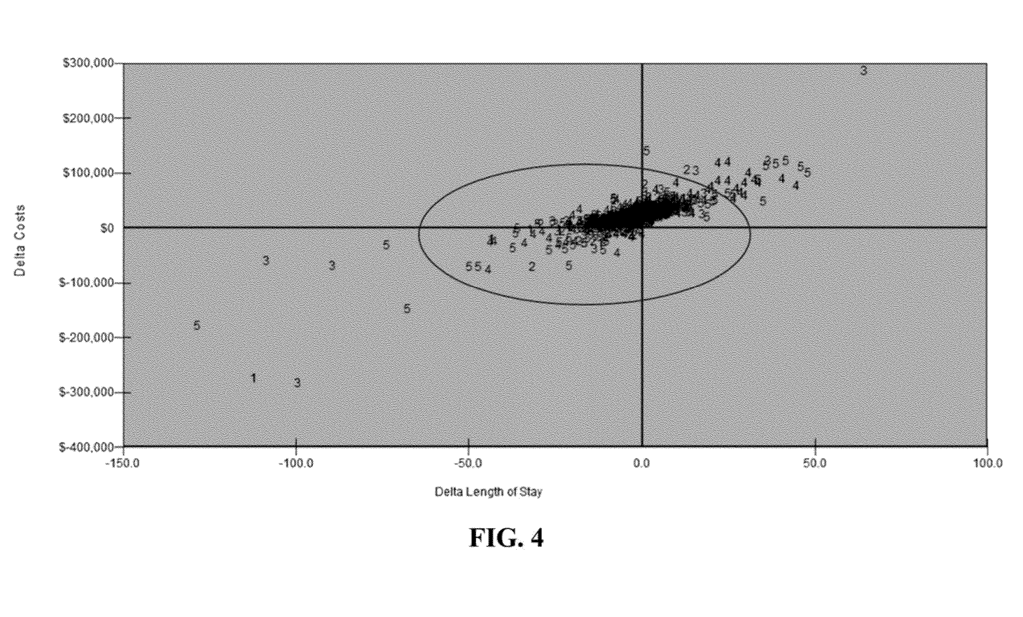

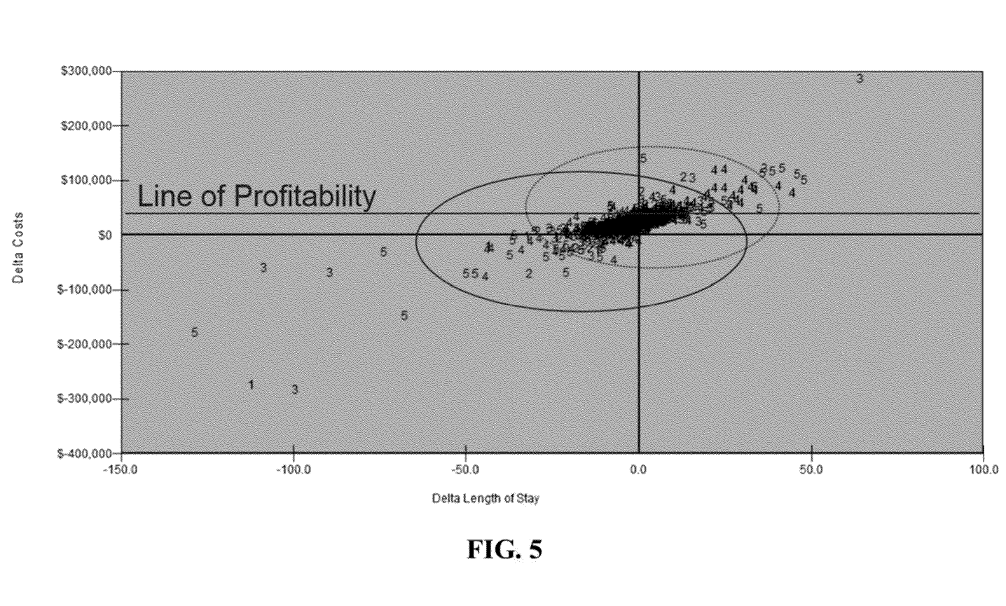

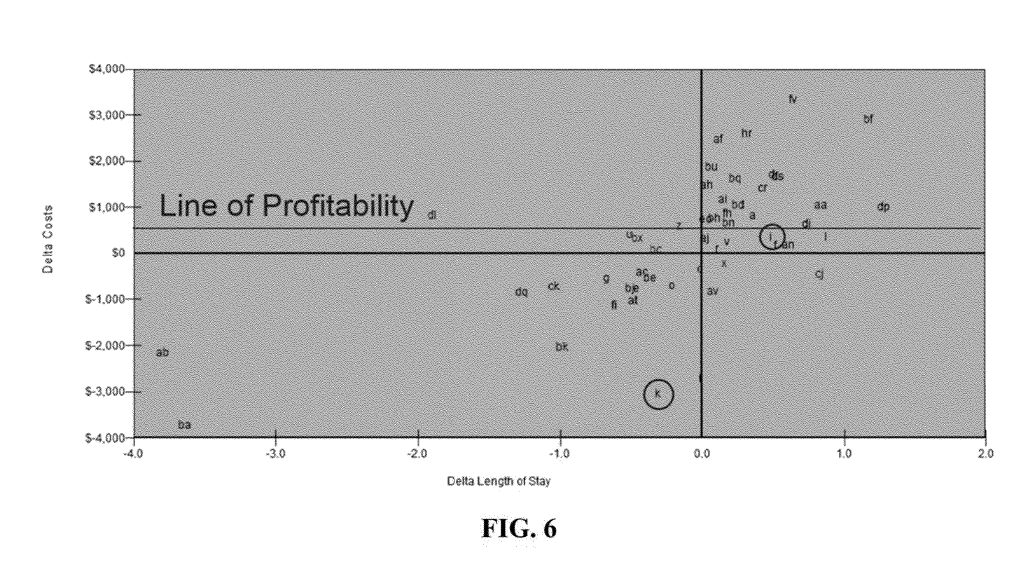

FIG. 4 depicts a four-quadrant graph showing a scatter-gram of patient outcomes compared to internal risk-adjusted norms, based on costs and length of stay, and having a represented standard deviation oval. Regarding outcomes clinical and financial assessments, Verras computes a hospital's and medical staffs' DRG-based outcomes using the three most recent years of hospitals' severity-adjusted data. Mortality and Morbidity rates as well as other outcomes are concomitantly recorded for each Clinical Service (Cardiology etc.). Cost and LOS data are then graphed at the DRG, individual patient (see FIG. 4 and FIG. 5) and physician levels (see FIG. 6). The outcomes are compared to internal risk-adjusted norms and plotted on a 4-quadrant graph for ease of interpretation. Each physician's outcome averages (see FIG. 6) are displayed using symbols in place of names. These outcomes measures are the first step in facilitating the doctors' understanding as to the specific processes and resources he/she used to produce the observed results. From a functional standpoint, these are powerful, previously unappreciated clinical facts that are the basis on which the practicing doctors will modify their ordering patterns. Without these types of specific data created using the doctors' own information that defines their practices, the same unchanging, lamentable results must be expected.

FIG. 4, each number represents a patient and that patient's acuity (severity) level, as determined by Verras' AIM algorithms. AIM is scored from 1 to 5. Acuity Index level 1 represents the least acutely ill patient and a level 5 is the sickest. A two standard deviation oval indicates that 95% of the costs are contained within the oval. Patients that are above the horizontal line were managed more efficiently than the cost norms for each Acuity Index level and those to the right of the vertical line had lower lengths of stay than the LOS, severity norms. Hospitals are unable to produce such information for their doctors. When queried, doctors generally believe the variations per patient in terms of charges or costs are in the hundreds of dollars. They are amazed when they learn from these types of data their variances are in the tens of thousands of dollars per case

FIG. 5 depicts a four-quadrant graph showing a scatter-gram of patient outcomes compared to internal risk-adjusted norms, based on costs and length of stay, including a line of profitability, and having two represented standard deviation ovals. Referring now to FIG. 5, it is through the identification and repetitious utilization of the most efficient resources that physicians are able to continuously reduce variations that incrementally improve their own and the hospital's outcomes. The patients with the most efficient Cost and LOS outcomes are those located in the right, upper portion of the initial oval. As variations are reduced, using the processes of the best-demonstrated patients, the size of the 2 St. Deviation Ovals gets smaller and their Ave. (means) move up and to the right. Smaller variations indicate greater consistency in the way the patients are being managed. Order sets or similar tools are the more common means to accomplish these improvements over time. But improvements only occur when physicians' most effective and efficient resources, in the Green area, are used to construct the order sets. The vast numbers of physicians were never taught, nor have concerned themselves with the concept of Reductions In Variation (RIV) at the clinical level. They generally believe this is a hospital concept to be used at the organizational level.

FIG. 6 depicts a four-quadrant graph showing a scatter-gram of patient outcomes compared to internal risk-adjusted norms, based on costs and length of stay by physician, including a line of profitability. In FIG. 6, the physicians' symbols that are above the horizontal ($0) line, managed their patients with fewer costs than the norm. Those to the right of the vertical line had patients with LOS shorter than the norms. Note that only those physicians' outcomes that are above the “Line of Profitability” are actually profitable for the hospital. (Profitability levels are specific to each DRG and within each hospital.) With regard to processes assessments, the limitations imposed by only having outcomes data have been overcome by Verras' patient-level technology that identifies the specific, time-stamped, line item, hospital resources that are associated with physicians' most and least efficient practices. Unless they are at financial risk with their hospital, physicians do not concern themselves with the hospital's profitability, which is one of the primary reasons hospitals are having financial difficulties.

All resource consumption begins when a clinician writes an order. The ability of the tools and techniques contained this patent to influence physicians toward greater efficiencies may be the difference between a hospital's financial health and demise.

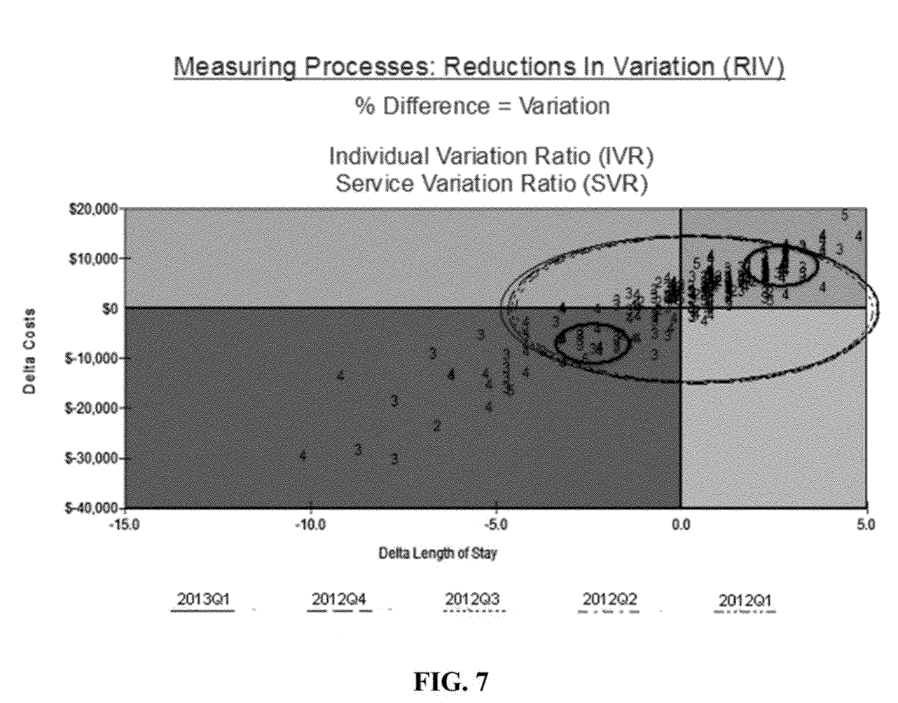

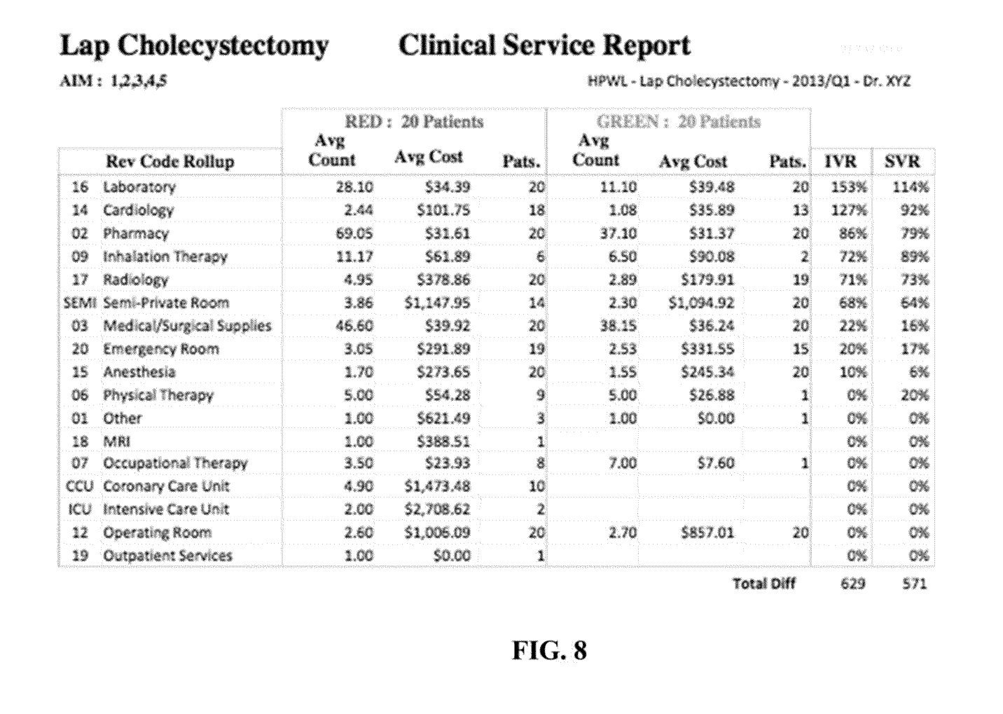

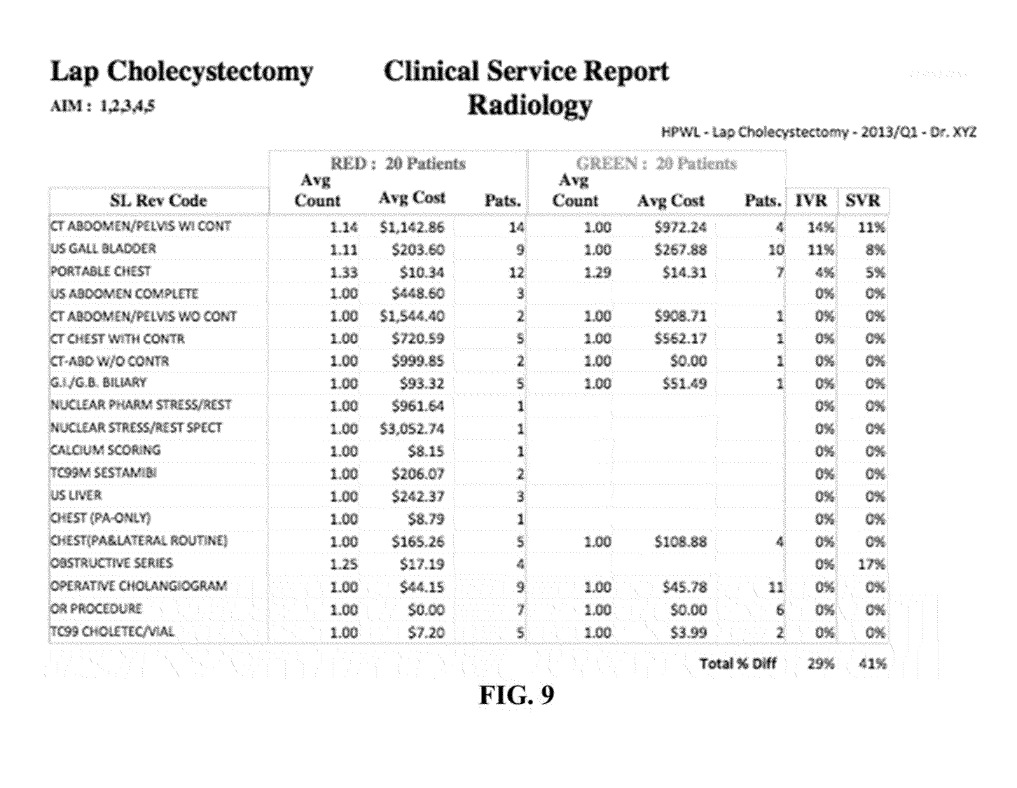

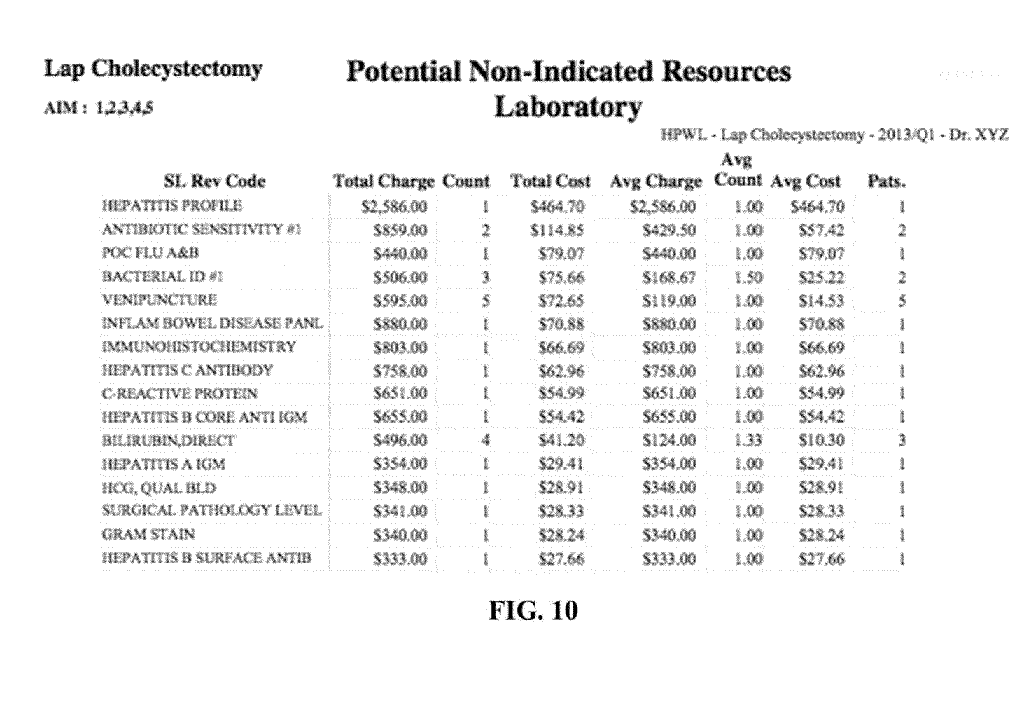

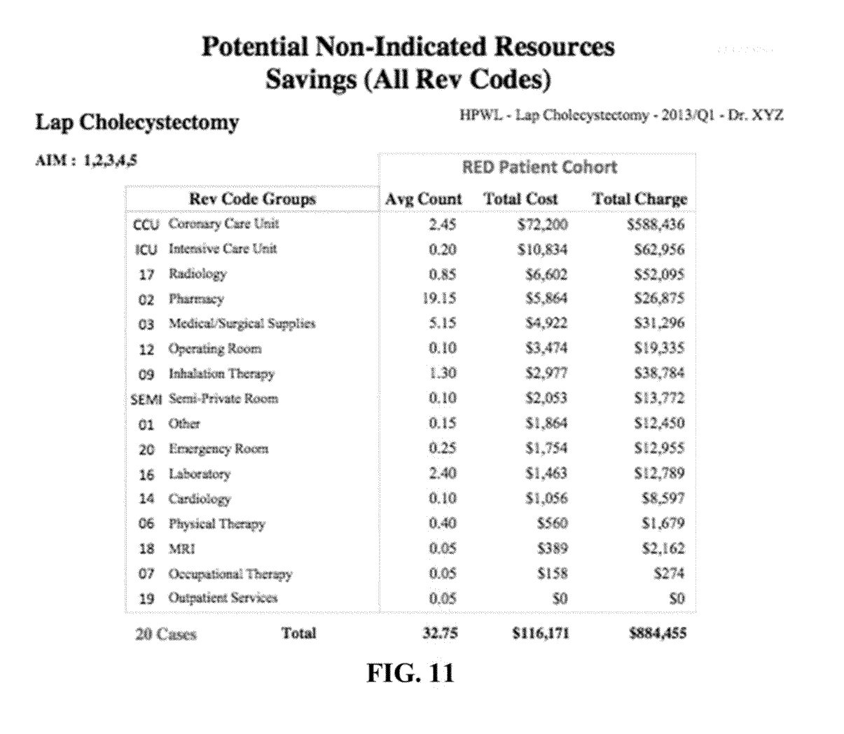

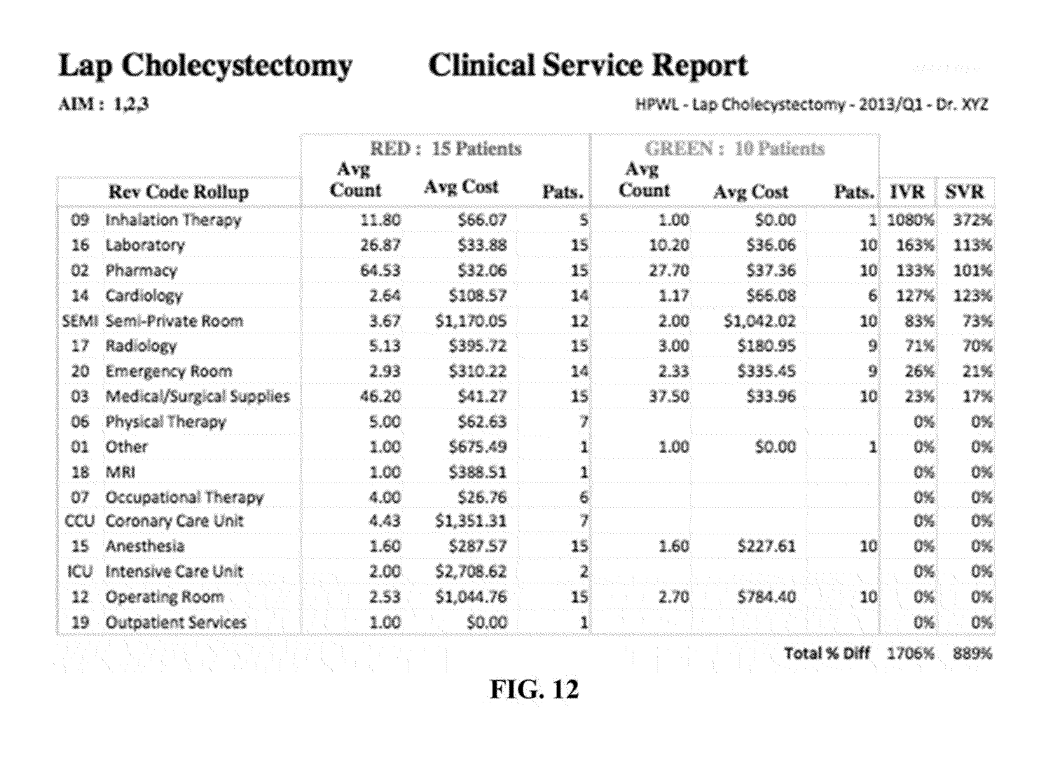

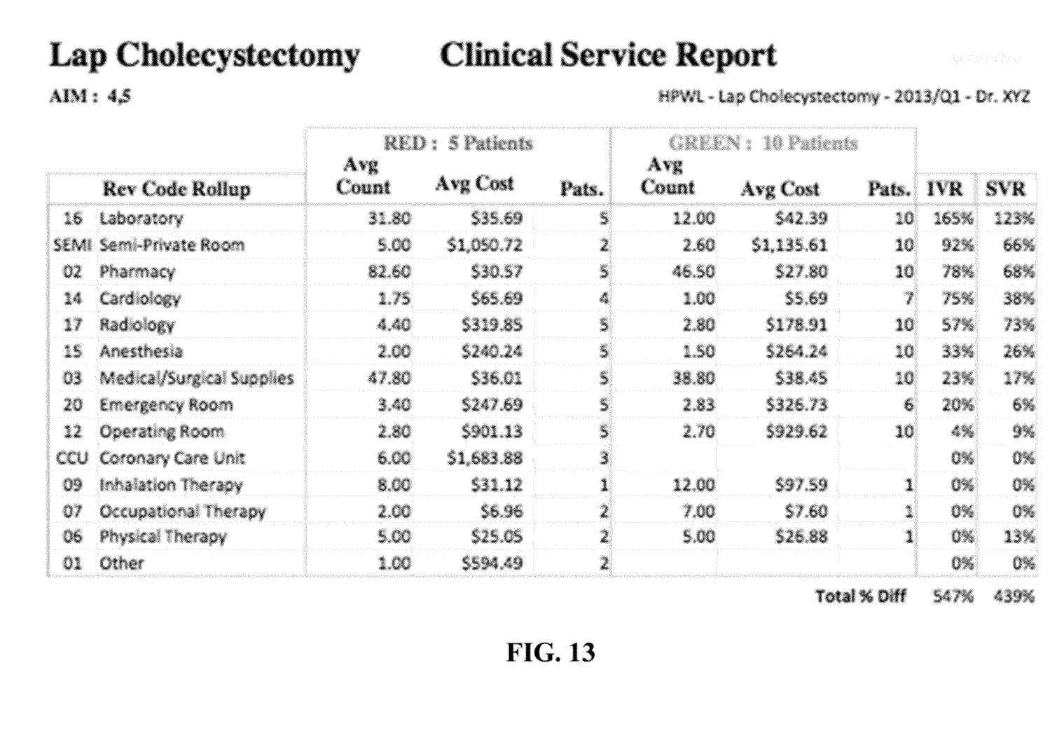

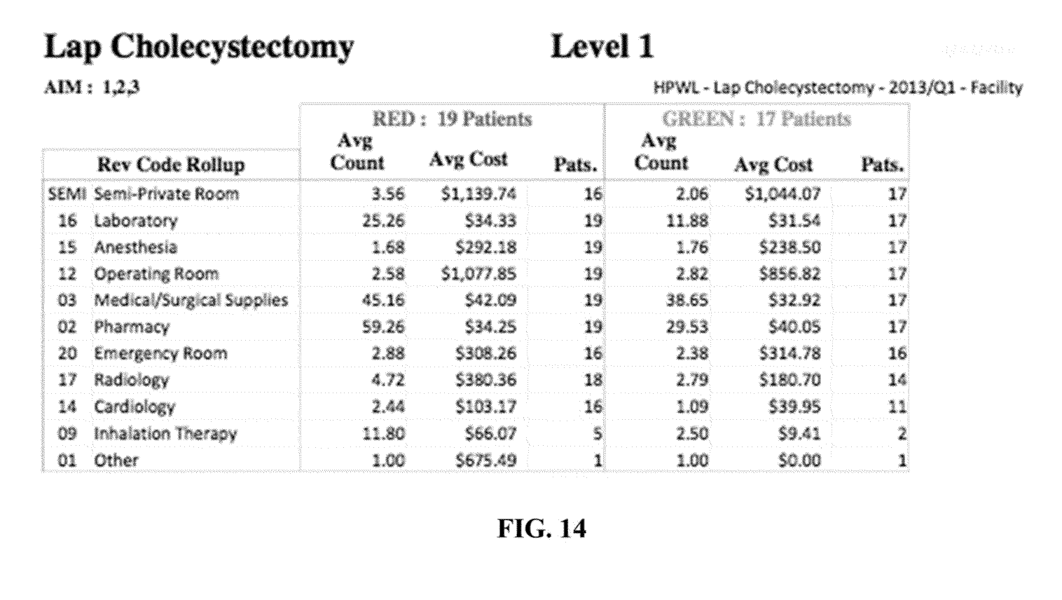

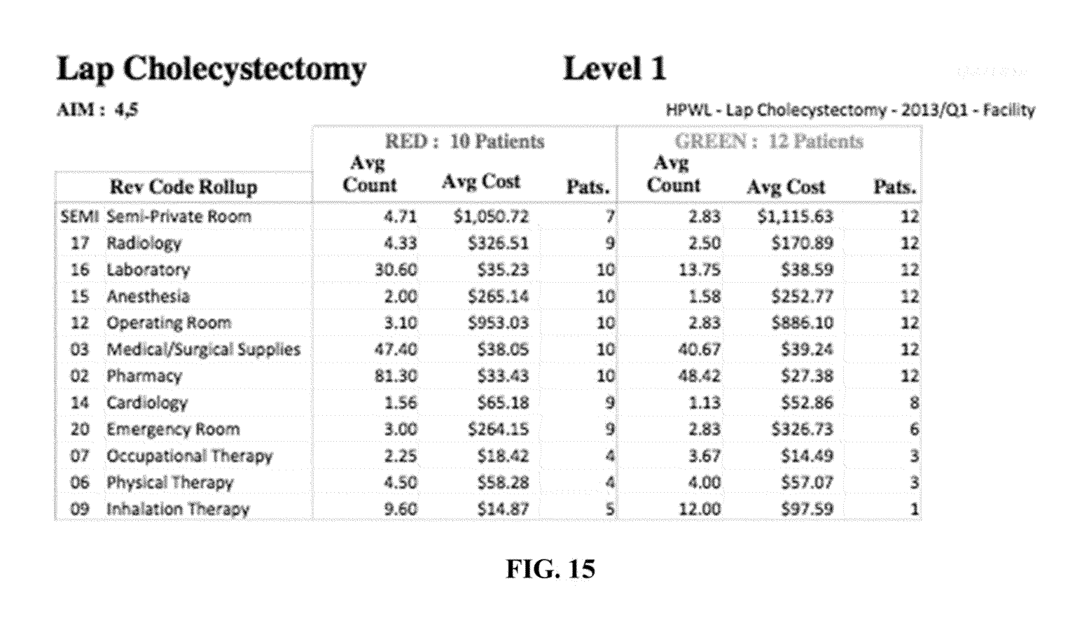

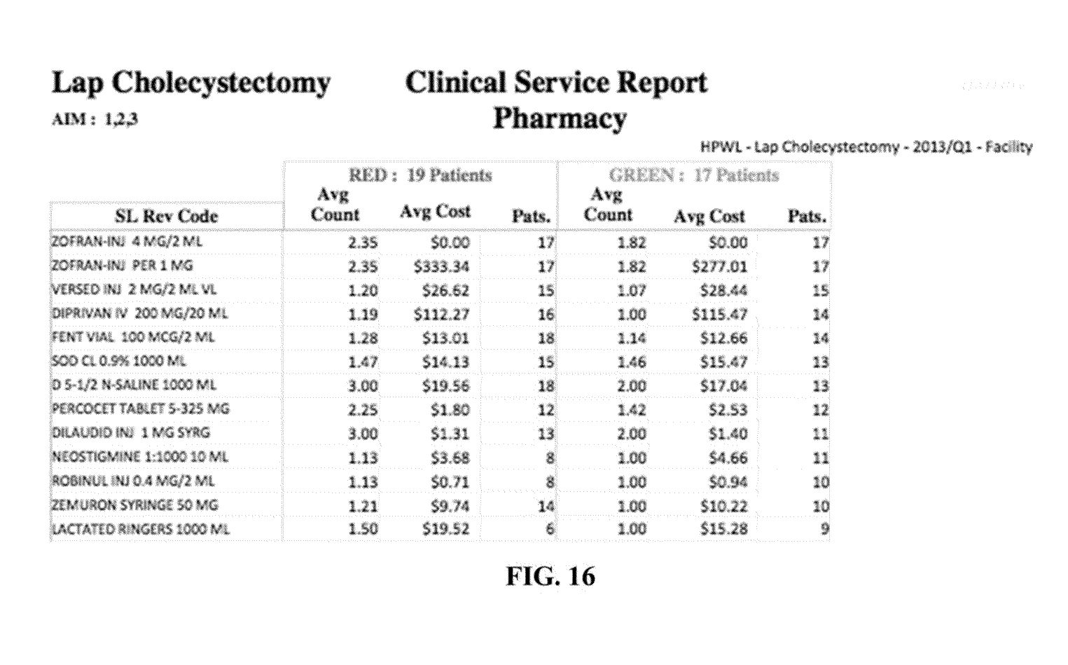

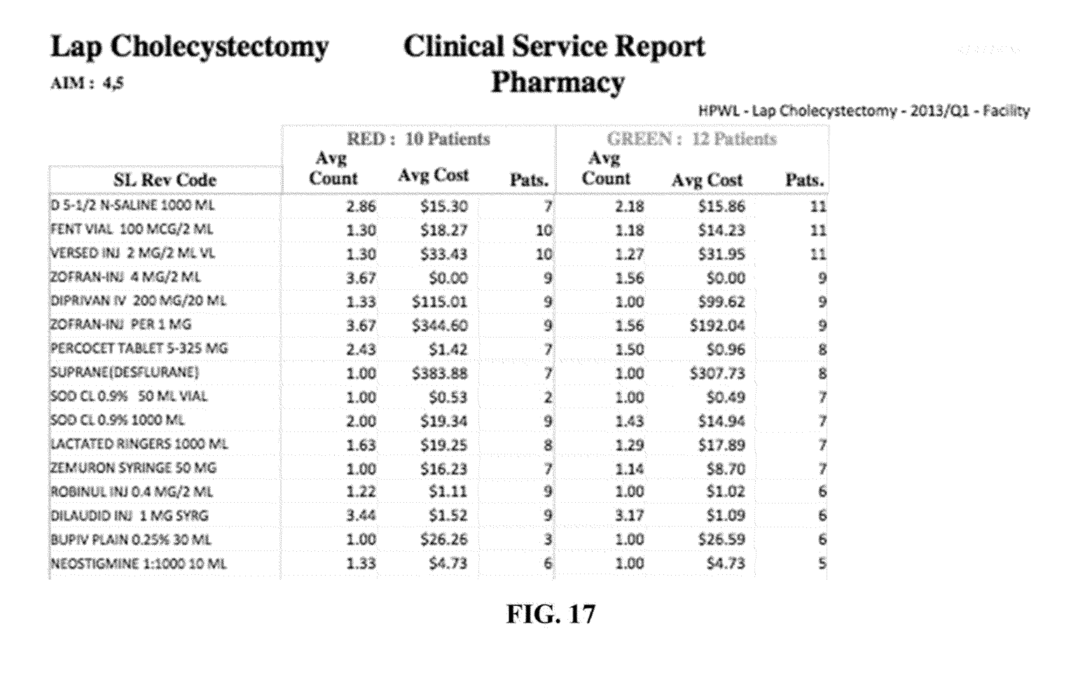

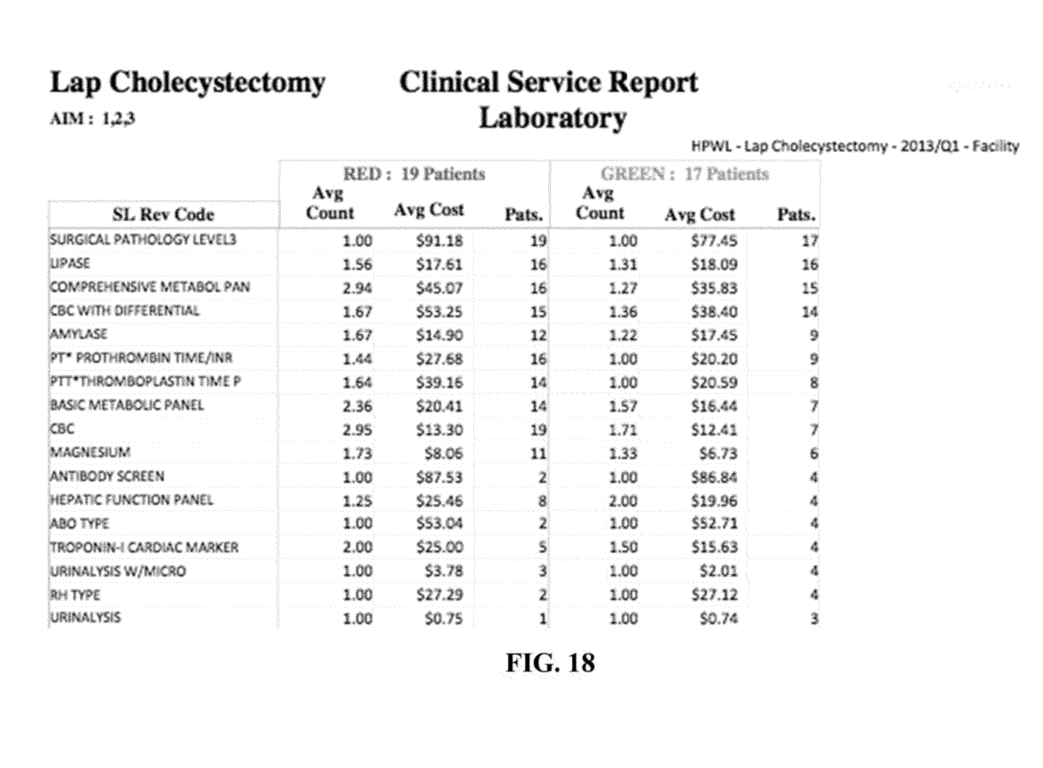

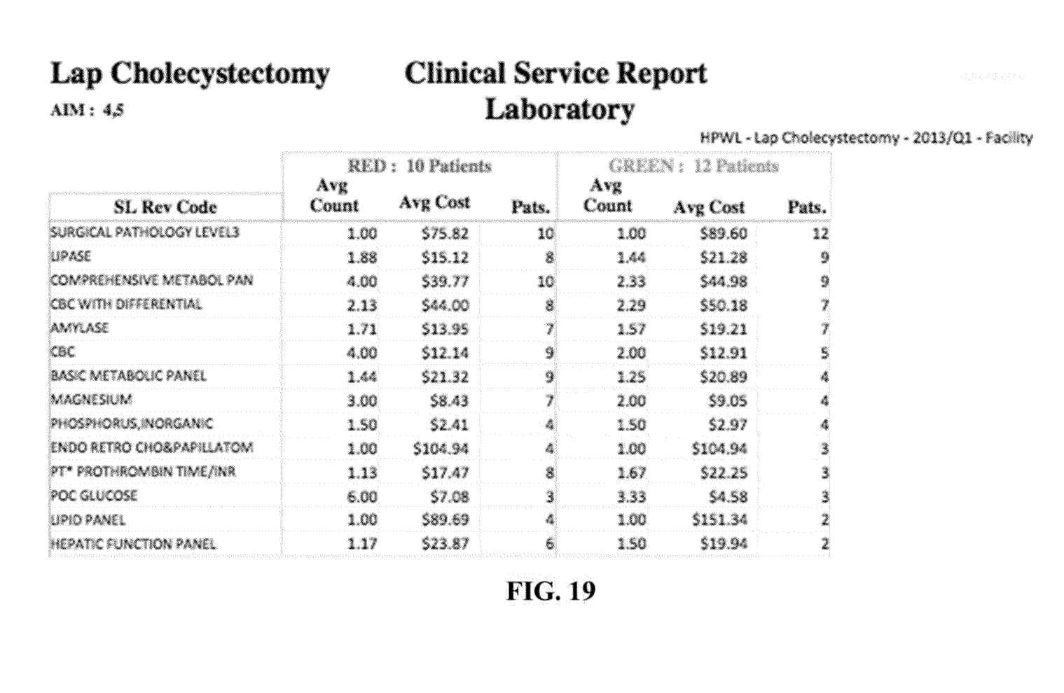

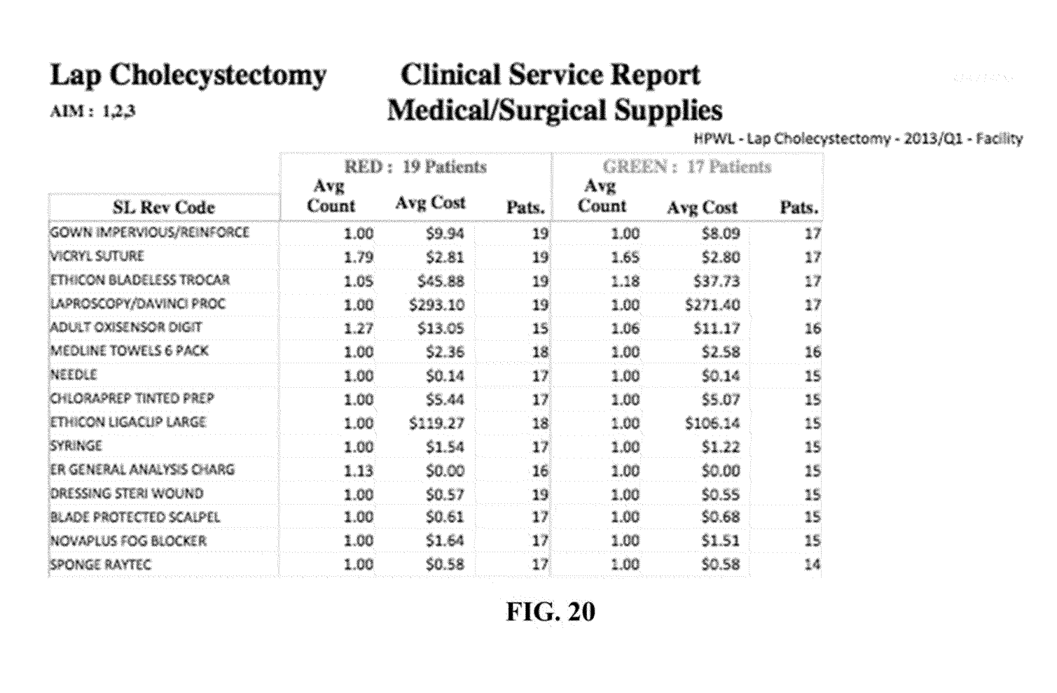

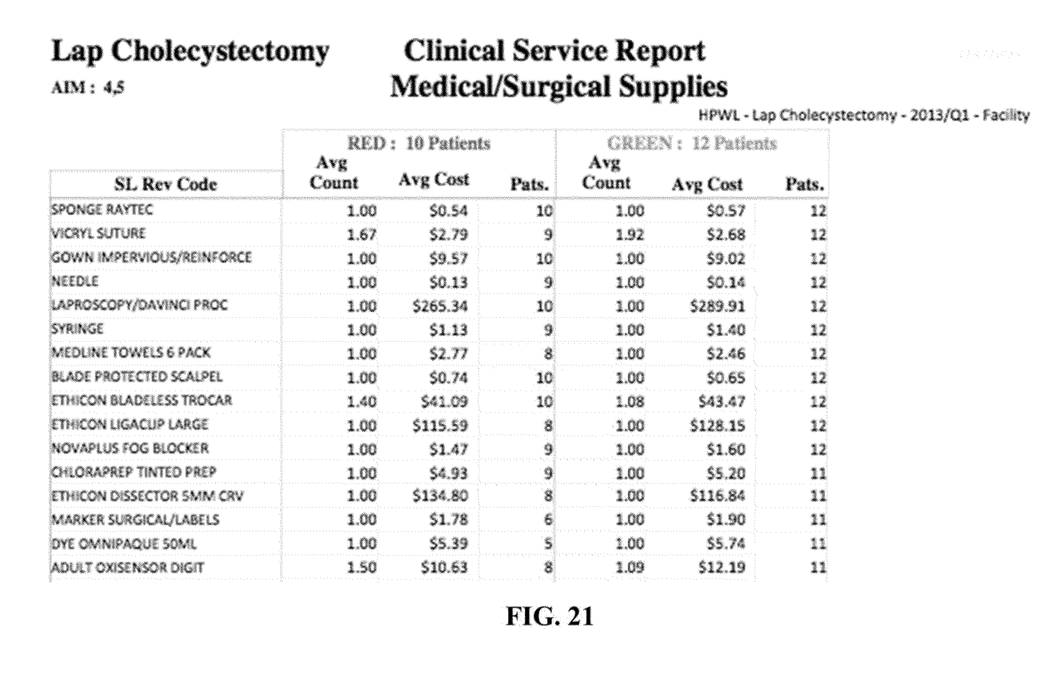

FIG. 7 depicts a four-quadrant graph showing a scatter-gram of patient outcomes compared to internal risk-adjusted norms, based on costs and length of stay, having three large standard deviation ovals and two smaller standard deviation ovals representing the most efficient and least efficient managed patients. In FIG. 7, the three large ovals represent the past three years of data with the solid oval being the last year (here 2013). This graphically demonstrates for physicians that variations are unchanged over the past three years. The most efficiently managed patients are those in the white oval in the upper right hand quadrant (or Green area) and the least efficient are those in the white oval in the lower left-hand quadrant (or Red area). These data associated with the two patient cohorts are objective, transparent and presented in a clear and incisive manner, which makes them comprehensible to physicians. (Patients that fall outside the two standard deviation oval, in the Red area, are those with complications, which are also quantified using other methods executed by the MVI and others, such as enumerating these patients' comorbidities.) Physicians and clinical service's line item data and calculations are used in order to improve clinical and financial outcomes at every level; variations in resource utilization must be reduced between the least and most efficient outcomes by replicating the processes and resources utilized for the most efficiently managed patients, which are those in the upper, right portion of the Green area (upper right hand quadrant).

FIG. 8 depicts a table illustrating a clinical service report for Lap Cholecystectomy, for all clinical departments, in the first quarter of 2013 for example Dr. XYZ, taking in to account all 5 AIM acuity (severity) factors. Each patient's acuity (severity) level is determined by Verras' AIM algorithms where AIM is scored from 1 to 5, with an Acuity Index level 1 representing the least acutely ill patient and a level 5 representing the sickest, most critically ill patient. In order to implement physician directed, best practice improvements, the present invention generates the following Verras analytics for the purpose of creating Physician and Clinical Service (Cardiology etc.), Line Item (Lab tests etc.) calculations that demonstrate where RIV of specific resource utilization processes will optimize each physician's and the hospital's clinical and financial outcomes.

Referring to FIG. 8, the table here illustrates how twenty-three (23) Clinical Service Rollup Groups (Laboratory, Pharmacy and Radiology etc.), and many Line Item Data (CBC, Penicillin and Chest X-ray etc.) from hospitals' charge masters are the data used for the analyses. Resource utilizations at these two levels are displayed for physicians as average (Ave.) Counts and average (Ave.) Costs per patient within the hospitals' 23 revenue (here abbreviated Rev.) Code Groups that are listed on the left of the table in FIG. 8. Each individual physician's most and least efficient resource utilizations are compared in order to demonstrate variations between the two utilization cohorts (Red for the left-hand column and Green for the right-hand column) that are usually based on 20 cases each. The variations between the two cohorts are quantified as percent differences (% Diff). Additionally, each doctor's variations (Individual Variation Ratio [IVR]) are compared to the Ave. of his/her peers (Service Variation Ratio [SVR]) to contrast each doctor's variations with those of his/her peers and thereby stimulate physician-directed, best practice pattern changes.

With regard to clinical services (Facility or General Surgery for instance) and line item ratio calculations, the reports generate a ratio by contrasting the Ave Count of each resource between 20 or so patients with the most efficient outcomes performance (Green) to that of 20 patients with the least efficient performance (Red). Average Counts are used as opposed to Average Costs because physicians control the number of units ordered while the hospital charge master controls the charges or costs.

Also in FIG. 8 the percent differences are shown. Variations are recorded as % differences (% Diff) in the columns on the right of the tables. This % Diff is for a hospital facility's Clinical Service Ave (orthopedics etc.) and the Ave of each clinician's two cohorts for 23 Facility Service Lines (Lab, Pharmacy, etc.) A Clinical Service is a group of cardiologists, orthopedic surgeons, or the physicians who treat these types of cases. The calculation by Verras Watson of percentage differences is as follows: Ave Count [Red] minus Ave Count [Green] divided by the Ave Count [Green] equals the percent difference (% Diff) between the two cohorts.

The importance to practicing physicians of these data is, as Variation is reduced around the clinicians' best-demonstrated performances (Green); the % difference (as recorded as IVR or SVR) will decrease. (In each Clinical Service or Line Item entry, a negative % is recorded as 0%). Example: an SVR of 120% means the group of physicians being measured used 120% more resources on their Red patients than on their Green patients as measured by their Average Count for the resources in question. However, this information does not document what specific resources were used in either the Green or Red Areas. Those resources are detailed by specific reports on each of the Rev. Code Groups such as Radiology, which is used here as the example. Reducing variations in the use of each of these resources may seem small, but physicians can be shown that these incremental changes can translate to tens of thousands of dollars over a year for any group of their patients.

FIG. 9 This Clinical Service Report for radiology is an example of one of the 23 Rev. Code Groups. (as shown in FIG. 9). Specific, risk-adjusted data such as these facilitate physicians' abilities to modify their clinical practices to improve their patients' outcomes. Note the fact that this ordering physician did not see fit to do Calcium Scoring or Nuclear Stress Test on any of the patient in the Green cohort. These tests are indicated in the outpatient arena only. These tests were probably done as a “favor” to the patient so they would not have to reschedule another visit. The hospital receives no reimbursement for these tests. It is therefore important to demonstrate the economic ramifications of such inappropriate testing, which Verras does in a Potential Non-Indicated Recourse report.

Each physician receives a Potential Non-Indicate Resource (PNIR) report for each or his/her Clinical Service's Rev Code Rollup groups. (see FIG. 7) The PNIR Line Items listed have 1 or more entries in the Red patient cohort with none in the Green. Whether or not these resources are actually non-indicated can only be determined by the physician him/herself They are recorded only as “Potential” resources that may have been deployed inappropriately for the patients' clinical cohort being examined. A summary of all the Potential Non-Indicated Resources is recorded for each physician as averages for the number or these PNIRs for each of the Rev. Code groups as well as costs for each. (see FIG. 11).

Example Reports:

Definitions and Explanations:
Individual Variation Ratio (IVR) is defined by % difference between an individual physician's most efficient and less efficiently managed cases, within 2 St. Deviations for a Diagnoses or Procedures.
Clinical Service Variation Ratio (SVR) is defined by % difference between the most efficiently and less efficiently managed cases, within 2 St. Deviations for a Diagnoses or Procedures of the average of physicians in a clinical service, or doctors who manage similar patients. The smaller the percentage (%) of the IVR and SVR the better, as it indicates greater consistencies.
Using Verras Watson, every Service Line for each clinical service may be selected for drilling down to the physicians' Order Levels e.g. Lab, Pharmacy and X-Ray etc. for all cases or for less severely ill patients (Acuity Index 1, 2, 3) or most acutely ill patients (A.I. 4, 5).
Physicians control the number of units ordered for any resources consumed while the hospital control the costs. Therefore, percent differences are calculated for the counts per patient instead of costs per patient because it is more appropriate from the physicians' perspective.
Potential Non-Related Procedure Reports are recorded for a specific line item if the Facility's Clinical Service's Red Count is 1 or > and Green Count is 0. This report highlights resources that were consumed that “Potentially” had marginal indications for deployment.

In this Individual Clinical Service Report for the General Surgeons regarding laparoscopic cholecystectomies, the IVR ratio is recorded in the second column from the right-most column for physician XYZ. It compares the Ave. Count/Pt. of resources utilized between his/her most and least efficiently managed patients for all Lap. Cholecystectomy Patients.

It is important that Doctor XYZ be informed that he used 153% more Laboratory resources in his/her Red Cases (Avg. Count—28.10) than he/she used in his/her Green (Avg. Count—11.10) cases. Contrast this 153% variation figure with the lesser variation figure 114% of the General Surgery Group's Ave (SVR). The IVRs and SVRs are totaled at the bottom of the column as Total Diff. (This is not a true total of percentages, it is meant to convey a general comparison of the totals for the education of the doctors to assist them in determining their relative consistencies compared to their peers.)

Any IVR larger than 500% is an outlier and should be used only as an indicator for further investigation. It should not be included in a physician's final interpretation of the total difference between IVR and SVR. However, such outliers often serve as ax very useful indicator of a specific inefficiency in the doctor's ordering pattern.

Dr. XYZ's Total % Diff of 629 indicates generally wider variations than the 6 other Gen. Surgeons groups' 571 for all Clinical Service Rev Code Rollup figures for Lap Cholecystectomies. Again, this is an indicator for the doctor as to his/her relative consistency and efficiency. Data this specific can only be obtained using integrated technologies and techniques of data manipulation.

FIG. 9 depicts a table illustrating a clinical service report for Lap Cholecystectomy, for just the radiology clinical department, for a year that includes the first quarter of 2013 for example Dr. XYZ taking in to account all 5 AIM acuity (severity) factors. With regard to individual line item ratios—Radiology (General Surgery—Lap Cholecystectomy), FIG. 9 illustrates this generated report and presents each physician with his/her own Clinical Service and Line-item details for any of the 23, selected Rev. Code Groups, displayed by descending IVR % Diff. Each physician's IVR is compared to the Service's SVR as shown in the far right column. (Radiology is selected for this example.)

To facilitate physicians understanding of their practice variations, it is paramount to be able to deploy technologies for risk adjustment, coordinated with the ability to select efficient and inefficient patient cohorts for analysis. From those cases 20 selected cases of physician XYZ's most efficiently managed cases (Green), 4 of the patients received “CT ABDOMEN/PELVIS WI CONT”. Each patient having one performed (Ave. Count)=1.00. Fourteen (14) Of Dr. XYZ's 20 cases in the Red had this procedure, however two patients had 2 “CTs ABDOMEN/PELVIS” because the Count/Case=1.14. This brings up the question of whether these second procedures were ordered because the patients actually needed 2 of the same procedure during the one hospitalization, or because a consultant did not realize the procedure had been performed and mistakenly ordered a second procedure of the same type —which is a frequent observation. Only the physician can make the determination as to the inappropriateness of this duplication.

In FIG. 9, the technologies are then able to demonstrate physician XYZ's total IVR (29%) being lower than the Clinical Services Ave. (41%) indicating his/her variations for Radiology is less and therefore more consistant than that of the group's Radiology Ave.

FIG. 10 depicts a table illustrating Potential Non-Indicated Resources service report for Lap Cholecystectomy, for just the laboratory clinical department, for a year that includes the first quarter of 2013 for example Dr. XYZ taking in to account all 5 AIM acuity (severity) factors. For Potential Non-indicated Resources, Laboratory (General Surgery—Lap Cholecystectomy) FIG. 10 illustrates how each physician receives this report for one or more of his/her Clinical Service's Rev Code Rollup groups. (This example will use Laboratory.) The report is available for all Rev Code Groups. The Line Items on this report have 1 or more entries in the Red (inefficient) cohort with none in the Green.

In FIG. 10, of physician XYZ's 20 patients, each had an Ave. Count of 2.4 PNIR with total charges of $12,789.00 and total costs of $1,462.78. Some percentage of these PNIRs may not have been indicated for these patients, but this determination is the ordering physician's decision alone.

FIG. 11 depicts a table illustrating Potential Non-Indicated Resources savings service report for Lap Cholecystectomy, for all clinical departments and all revenue codes, for a year that includes the first quarter of 2013 and for Dr. XYZ, takes in to account all 5 AIM acuity (severity) factors. As is shown here in FIG. 11, for Potential Non-Related Procedures, All Rev Codes (General Surgery—Lap Cholecystectomy), each physician receives this report for all of his/her 23 Clinical Service's Rev Codes. As with the individual Rev Code Groups, these Line Items have 1 or more entries in the Red cohort with none in the Green. Note the Total Charges, Counts and Costs recorded below. Total Costs of $116,171 are only for this one physician and for only 20 of his/her cases. (This doctor had more than twice that number of cases.) If the physician is willing to critically evaluate these potentially extraneous resource usages, which they are generally very interested to do, significant costs may be averted during the next year.

Documenting efficiencies in lower acuity patients and higher acuity patients in an important concept. Physicians often harbor a misperception of the data that less sick (lower acuity) patients are those found in the Rt. Upper Quadrant (Green), while the sicker (High Acuity) patients (Left Lower Quadrant) are in the Red. This technology is able to demonstrate that this is not the case, which leads to the doctors' acceptance of Two Level Clinical Pathways.

This question is important to answer with data because a majority of hospitals and physicians have spent a great deal of time and money in an effort to reduce clinical variations using order sets from various sources. Irrespective of the source of externally generated clinical pathways, the resulting outcomes seldom demonstrate improvements because they were not created using their own best practices. In fact they most often show no change or a worsening of outcomes.

One of two things generally happens after a year or two of implementation using these types of order sets. Either variation is reduced by collapsing around the mean with no change in outcomes, or there are greater resources consumed than before the order sets were implemented. This is because the clinical pathways or orders sets were designed to care for the most acutely ill patients. The higher acuity patients are then relatively well managed but the less acutely ill patients have many more resources ordered for them than are appropriate. This is compounded by the fact that there are usually more of the lesser acutely ill patients therefore even greater inefficiencies. This is the reason the technologies and methods contained in this patent for creating objectively defined, Two Level Order Sets is so important to the future of future American healthcare delivery.

For an example of the output of these technologies and their benefits. Compare Total % Diff. between FIG. 12 and FIG. 13, where the Total % Diff are smaller, and therefore more efficiently managed for the Higher Acuity Patients (see FIG. 13) than the less acutely ill patients. (see FIG. 12). Excess resource consumptions during patient care have both quality and inefficiency implications because every test and treatment has established, associated complications rates associated with them. Physicians cannot practice high quality, cost efficient medicine if they overuse resources because patients may experience complications to tests or treatments that had marginal indications. Without the tools and techniques of this patent, the same inefficiencies will continue in every hospital.

FIG. 12 depicts a table illustrating a clinical service report for Lap Cholecystectomy, for all clinical departments, in the first quarter of 2013 for example Dr. XYZ, taking in to account AIM acuity (severity) factors 1, 2 and 3 only. A single order set should not be constructed for a single DRG because the patients in A.I.s 1 thru 5 are too dissimilar. The Acuity Index 1, 2 and 3 (see FIG. 12) patients are relatively homogeneous as are the A.I. 4 and 5 (see FIG. 13) patients. Therefore, two orders sets should be designed for each DRG—one for the lower acuity patients (see FIG. 14) and one for the high acuity patients (see FIG. 15). When these two cohorts are evaluated independently the issue as to which cases are more efficiently managed becomes clear and the solution to future management is also made manifest.

The following data are typical of patients that were managed using a single order set or clinical pathway (compare FIG. 12 and FIG. 13). Note that for Dr. XYZ's less severe patients (where A.I. is 1, 2 or 3), the total Rev Code Group Roll up IVR is 1706%. (It is actually 626% when the single patient for inhalation therapy is removed.) The 626% total demonstrates greater consistency than his/her peers' whose SVR=889%.

Now observe his/her Total IVR for patients in the higher acuity group, A.I. 4 and 5, which equals 547%, while the SVR for the group totals 439%. Here, physician XYZ is less consistent than his/her peers.

However, both physician XYZ and the peer group are more consistent in the sicker patients (A.I. 4, 5). Moreover, the distributions of the 1, 2 and 3 are relatively equally distributed throughout the Green and Red cases as are the 4's & 5's. This dispels the contention that all the 1, 2 and 3's are in the Green and that the 4's & S's are in the red, which was initially and erroneously assumed. For physicians using these technologies and methods, this is always a revelation. They quickly make the connection that if they know how to manage their sickest patients efficiently, they can certainly manage to Lower Acuity group more efficiently. Having the technology to create the Two Level Order Sets will insure they continue to make improvements in their patients' outcomes.

FIG. 13 depicts a table illustrating a clinical service report for Lap Cholecystectomy, for all clinical departments, in the first quarter of 2013 for example Dr. XYZ, taking in to account AIM acuity (severity) factors 4 and 5 only. Creating hospital specific, base order sets using physicians' best-demonstrated outcomes works as follows: Using Verras' technologies and techniques, each doctor is able to correlate his/her diagnostic and treatment resources with the hospital's objectively defined, Cost and LOS outcomes. This is accomplished by first identifying a relatively homogeneous subset of patients with the highest quality, most cost efficient outcomes (Right Upper Quadrant of FIG. 7, see above) then modeling future patients' care around the specific resources used to produce these patients' specific resource consumptions and subsequent superior outcomes.

With the technologies and processes described by this patent, doctors can establish sets of medical orders for future patients' diagnoses and treatment plans that are based on evidence-based literature, but equally important, on the doctors' and their hospital's best-demonstrated care processes and resource consumptions. However, the initial identification patient subsets (Right Upper and Left Lower Quadrants of FIG. 7) are not sufficiently similar in severity to create order sets because they contain patients with Acuity Indices of 1 through 5. Therefore, a more homogeneous subset of patients can be established for the lesser acuity patients (A.I. 1, 2 & 3) and for the higher acuity (A.I. 4 & 5) patients.

FIG. 14 depicts a table illustrating a Level 1 service report for Lap Cholecystectomy, for all clinical departments, for the previous year including the first quarter of 2013 for the entire physician group (Facility), taking in to account AIM acuity (severity) factors 1, 2 and 3 only. Using only the resources from the more efficiently managed cases (Green) in both the lesser (see FIG. 14) and higher (see FIG. 15) acuity patients, separate Base Order Sets can be constructed using the Order Levels of all 23 Rev. Code Groups. The resultant two order sets are thus constructed and represent the physicians' highest quality, most cost efficient outcomes for their respective risk-adjusted cohorts. Using these 2 order sets for the next 6 or 12 months will virtually guarantee that patients' outcomes will improve. This same order set construction should be repeated at least yearly to ensure continuous RIV and quality improvements. It is also important to note that these order sets are hospital-specific. They should be transposed to other hospitals and physician groups only with great attention to detail in the differences between the two hospitals, because inefficiencies may be created.

Some hospital administrators believe order set standardizations should be imposed across hospitals because there is a “one best way to practice for all diagnoses and procedures”. Comparative hospital data do not support this contention (which is the reason for being cautious about using order sets across hospitals).

However, within each hospital, patient populations are more homogeneous than those of an entire city or state and over a year's time, each physician manages patients throughout that hospital population. Physician comparisons are therefore reasonable. Moreover, clinicians and hospital personnel who work and reason together can use risk-adjusted, clinical information and produce relatively stable and continuously improving clinical outcomes through reductions in variation. But there is another important cultural issue to consider in today's medical environment and that is physicians are reticent to use order sets that were not produced by themselves and their hospital's clinical colleagues. Experience indicates that comparing each physician to him or herself and then the comparing the physician to his/her peers is well received.

Base Order Sets are the most expensive portions of resource frameworks used by physicians and hospital clinicians to construct their hospital's final order sets. Other processes, such as diets, vital sign recording requencies etc., must be added to these base orders. The laboatory, X-ray etc. resources described by these techniques are the most expensive but not the only resources that determine physicians' guidelines for use during the subsequent 6 or 12 months. After that time, the data should be re-run and this entire process re-evaluated to create a new and improved order set. In this manner, continuous quality and cost efficiency improvements will be ensured.

FIG. 15 depicts a table illustrating a Level 1 service report for Lap Cholecystectomy, for all clinical departments, for the previous year including the first quarter of 2013 for an example Facility, taking in to account AIM acuity (severity) factors 4 and 5 only (High Acuity Patients).

FIG. 16 depicts a table illustrating a clinical service report for Lap Cholecystectomy, for the pharmacy clinical department, in the first quarter of 2013 for an example Facility (entire group of physicians in the hospital), taking in to account AIM acuity (severity) factors 1, 2 and 3 only (Low Acuity Patients).

FIG. 17 depicts a table illustrating a clinical service report for Lap Cholecystectomy, for the pharmacy clinical department, for the previous year including the first quarter of 2013 for a Facility (entire patient group), taking in to account AIM acuity (severity) factors 4 and 5 only. N.B.—of the possible 23 Rev Code Groups, only Pharmacy, Laboratory and Medical/Surgical Supplies will be discussed.

Pharmacy:

Each of the Rev Code Rollup Groups should be used to create the initial Base Order Sets. Pharmacy Order Levels that have been demonstrated to be the most efficient in both Low Acuity (see FIG. 16) and High Acuity (see FIG. 17) Cohorts. Note the differences in efficiencies between the Green and Red cohorts by comparing the Counts/patients for many of the line-items and it become clear why only the Green cohort is utilized to form Order Sets for future patient management.

As an aside, there are often fewer A.I. 5 patients, as is seen here (see FIG. 17), particularly during the early attempts to create Base Order Sets. This is usually because the Clinical Documentation Improvement activities have not been in place for a sufficient amount of time to accurately demonstrate the true acuities of the sicker patient populations. Documentation of all complications and comorbidities to accurately assess patients' severities is critical—at every level of patient evaluations. This is another level of detail that these technologies and techniques expose to improvements by physicians, once they are discovered.

FIG. 18 depicts a table illustrating a clinical service report for Lap Cholecystectomy, for the laboratory clinical department, for the past year including the first quarter of 2013 for an example Facility, taking in to account AIM acuity (severity) factors 1, 2 and 3 only. The specific laboratory tests ordered for the less acutely ill patients (A.I. 1, 2 and 3) (see FIG. 18) are generally different from those ordered for the A.I. 4, 5 (see FIG. 16 previously described) because of the greater number of co-morbid conditions being medically managed for the higher acuity (sicker) patients.

The laboratory resources for each of the two cohorts of patients (A.I. 1, 2, 3 and 4, 5) will be extracted from the best-demonstrated cases (Green). This importance of there techniques being automate is paramount for without this ability, the volumes of data are overwhelming to the hospital personnel and phsicians.

FIG. 19 depicts a table illustrating a clinical service report for Lap Cholecystectomy, for the laboratory clinical department, for the previous year including the first quarter of 2013 using an example, Facility (entire group of physicians managing this condition), taking in to account AIM acuity (severity) factors 4 and 5 only.

FIG. 20 depicts a table illustrating a clinical service report for Lap Cholecystectomy, for medical/surgical supplies department, in the first quarter of 2013 for an example Facility, taking in to account AIM acuity (severity) factors 1, 2 and 3 only.

Surgical cases, such as Laporascopic Cholecystectomies, consume greater resources in this Medical/Surgical Supplies Revenue Code Group than do medical patients. The differences in cost of implants and high tech equipment generally precipitate a discussion among surgeons as to which are more efficacious etc. Such discussions evolve into consensus building when equipment choices can be limited to equally effective, but less costly pieces of surgical materials. Two separate order sets are created for the less acuity ill patients (see FIG. 20) and higher acuity patients (see FIG. 21).

FIG. 21 depicts a table illustrating a clinical service report for Lap Cholecystectomy, for medical/surgical supplies department, during the past year and including the first quarter of 2013 for an example Facility, taking in to account AIM acuity (severity) factors 4 and 5 only.

The physician-directed reductions in clinical variation shown in the drawings and described in detail herein disclose arrangements of elements of particular construction and configuration for illustrating preferred embodiments of structure and method of operation of the present invention. It is to be understood however, that elements of different construction and configuration and other arrangements thereof, other than those illustrated and described may be employed for providing a physician-directed reductions in clinical variation in accordance with the spirit of the invention, and such changes, alternations and modifications as would occur to those skilled in the art are considered to be within the scope of this invention as broadly defined in the appended claims.

Further, the purpose of the foregoing abstract is to enable the U.S. Patent and Trademark Office, as well as patent offices worldwide, and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### INDUSTRIAL APPLICABILITY

the ability for physicians and hospitals to utilize technologies and techniques to correlate every physician's diagnostic and treatment resources with the hospital's objectively defined, superior, patient outcomes in order to treat patients in the most effective and efficient manner possible.
the ability to use Sherlock, which arranges the data provided by AIM for full drill-down analysis, allowing inspection down to the lowest element in a hierarchical arrangement and uses the risk-adjusted hierarchical data to calculate LOS and Cost variations at the patient level.
the ability to utilize the outputs of these calculations and combine them with the third technology, Verras Watson™ that compares and illustrates the test and treatment detail for those patients' with high quality and cost efficient outcomes vs. those with lower quality and inefficiencies.
the ability of the technologies and methods to demonstrate through objective data, the advantages of Two-level, Base Order Sets by risk-adjusting patients' data then create bifurcated order sets into Low Acuity and High Acuity clinical pathways for each clinical condition.
the ability to use previously purchased or created Order Sets and with the technologies and techniquare refine the traditional, single-level order sets to eliminate their drawbacks by bifurcating them and increasing their efficiencies.
the ability to further refine hospital data using risk-adjusted, patient level information that facilitates clinicians' ability to reduce variations that were inadvertently introduced through doctors and hospitals' practice patterns during routine practices or when they used their standard, single level order sets.
the ability to utilize risk-adjusted data and create two patient cohorts within 2 St. deviations, using AIM (or comparable SOI data) with which to calculate variations within each physician's, each clinical services, each hospital's outcomes.
the ability to accomplish quality and cost efficiency optimization through the use of the UHDDS data to risk-adjusted hospital outcomes data, such as are calculated by the Acuity Index Method (AIM)* or other comparable severity of Illness systems.
the ability to create two, acuity adjusted cohorts, one that is more efficient with fewer costs and shorter LOS and another that is less efficient with longer LOS. The Watson system then analyzes each, using drill-down techniques, to their resource consumption Order Levels. Next Acuity-Adjusted, Two Level Order Sets can be created that are necessary to reliably produce continuous quality and cost efficient improvements in medical outcomes of hospitalized patients.
the ability to build the clinical pathways (Base Order Sets) using the hospitals' own data
the ability to demonstrates to physicians the importance of managing patient co-morbid conditions using a holistic approach of each patient's co-morbid conditions as well as his/her Principle Diagnosis to avoid lack of coordination, tremendous variation and inefficiencies that otherwise get introduced into the patient's care.
the ability to overcome the traditional medical training and literature that perpetuate the standatd, single-condition focus of patient care using objective clinical data.
ability to trend data over time by risk adjusting a minimum of 3 consecutive years of all-payer, medical records data and time stamping each order to answer specific questions: who wrote the order, when was it ordered, was the care setting appropriate for the clinical condition and were the co-morbid conditions managed in a timely, effective and efficient manner.
the ability to quantify the contributions of each physician's diagnostic and treatment resources to the hospital's clinical and financial outcomes.
the ability to facilitation the drilling down to a hospital Order Level (Line Item) Data. These data types are Laboratory, X-ray, pharmacy and other resources from hospitals' Rev Code Groups.
the ability for clinicians and hospital personnel who use the technologies describe in this patent and reason together using risk-adjusted, Order Level to reliably produce stable and continuously improving clinical outcomes through reductions in variation.
the ability of the system to document effective resource usage in Lower Acuity Patients and Higher Acuity Patients separately, in order to facilitate the optimization and construction of the Two Level Order Sets.
the ability to utilize the hospital's Clinical Services (Lab, pharmacy etc.) data to drill down to Order Level (Line Item) that facilitates physicians' ability to maximize the hospital's quality and cost efficient outcomes.
the ability to calculate the variations between each physician's best and less efficient cost outcomes at the Order Level (line item) as a % difference and compare them to his/her peer variations in the hospital.
the ability for Verras Watson to quantify each physician's % difference in the use of each hospital resource (lab, pharmacy etc.) and makes the information available to clinicians who are constructing the Base Order sets.
the ability to create Two Order Sets per DRG, one to be used to treat “Low Acuity” patients [AIM 1, 2, 3] and the other “High Acuity” patients [AIM 4, 5.)
the ability to utilize the hospital's Clinical Services (Lab, pharmacy etc.) data to facilitate physicians' ability to maximize the hospital's quality and cost efficient outcomes without additional manual data abstraction being necessary.
the ability to provide doctors with information with which to decipher the myriad diagnostic and treatment resource usage combinations that they deployed to diagnose and treat patients, thereby providing physicians with feedback regarding their most efficacious and most efficient practices.
the ability to quantify the differences in each of the line-item data in terms of the cost differences between the inefficiently and efficiently managed cases, are multiplies by the number of Patient Counts, then aggregated for every pharmaceutical, every X-Ray, every Laboratory test, to calculate the inefficiencies that are in the millions of dollars per year per hospital.
the ability to assist physicians in creating Base Order Sets to facilitate their reductions in variation and quantifying the hospitals' net savings.
the ability to calculate every physician's diagnostic and treatment resource efficiency improvements using Verras Watson and objectively demonstrate improvements at the hospital level using MVI.
the ability to calculate every physician's diagnostic and treatment resource efficiency improvements using Verras Watson and objectively demonstrate improvements at the Clinical Service Level (cardiology etc.) using MVI.
the ability to enable further dissection and analysis of the six, industry standard, major metrics of medical quality. These measures are trended over three years and their outcomes are aggregated by the Medical Value Index, or other similar quality improvement calculations that further breakdown and analyze in greater detail the particulars of patient outcomes. National Hospital Quality Measures (mandated by the federal government), Re-admission rates (also mandated), Morbidity, Mortality, Reduction In Variation [RIV] and Resource consumption (Costs) are the measures incorporated into the MVI.
the ability to quantify quality (Morbidity, Mortality, Reduction In Variation [RIV] etc.) and resource consumption (Charges or Cost) metrics, which may be evaluated for each individual physician, each Clinical Service (Cardiology etc.), and the entire healthcare facility.
the ability to assess quality and efficiencies for each clinical service and, adjudicate what percentage of a hospital's net-saving that should be shared between the hospital and its physicians, as well as between the physicians of the various clinical services of the hospital.
the ability to demonstrate comparative value (quality and cost) among healthcare facilities (hospitals) and physician groups using the Medical Value Index system or any other product that assesses medical quality metrics.
the ability to objectively demonstrate to physicians that within virtually all Diagnosis Related Groups (DRGs), they invariably manage some of their patients using appropriate resources that objectively produced a cost savings per patient.
the ability to identify for physicians which specific resources not only improve their quality outcomes, but which were also responsible for profitability for their hospital's bottom line.
the ability to automate the processes of designing two Order Sets per DRG by identifying a relatively homogeneous subset of patients with the highest quality, most cost efficient outcomes, within specified acuity levels.
the ability to model the future patients' care around the specific resources used to produce these homogeneous patients' superior outcomes.
the ability for doctors to establish sets of medical orders for future patients' diagnoses and treatments that are based on evidence-based literature, plus equally important, on the doctors' and their hospital personnel's best demonstrated care process and resource consumptions.
the ability to design the highest quality, most cost efficient outcomes that are specific to each hospital and its medical staff.
ability to create two, risk-adjusted Order Sets by coordinating three, disparate technologies, AIM™* (or comparable risk-adjustment tool) and two associated technologies, Verras Sherlock™ and Verras Watson™, to target and analyze patient data including their diagnoses and procedures, as well as use of resources to provide a best practices framework for physicians' and facilities' future diagnoses and treatments.
the ability to define and risk-adjust two cohorts use Watson to further calculate the variation for each test and treatment between the most efficient and less efficient patients for each physician's practice and readily identify which of their patient cohorts have the most cost efficient outcomes to construct order sets that will eliminate excess variations and resource usage for future patients' treatments.
the ability to create clinical reductions in variation create efficiencies, which drive the necessity of operational efficiencies that may involve down- or right-sizing ability to assist hospital personnel with reductions in operational variations as well as clinical variations.

### REFERENCES CITED

1. Deming, W E. Out of the Crisis. Center for Advanced Engineering Study, Massachusetts Institute of Technology; Cambridge, Mass. (1982).
2. Juran, J M. Juran On Planning For Quality. The Free Press, New York, N.Y. (1988).
3. Berwick, D. (1989). Continuous improvement as an ideal in healthcare. New Eng. J. of Med., 320, 53-56.
4. Crimson: Crimson Clinical Advantage: Products: see http://www.advisory.com/technology/crimson/about-crimson-clinical-advantage
5. APR-DRGs: 3M HIS; APR-DRG Classification Software: see http://www.ahrq.gov/professionals/quality-patient-safety/quality-resources/tools/mortality/Hughessumm.pdf
6. Yale University; Development of DRGs; see http://library.ahima.org/xpedio/groups/public/documents/ahima/bok1047260.hcsp?dDocName=bok1_{—}047260
7. DRGs—Diagnosis Related Groups are the means by which Medicare and some insurance companies reimburse hospitals for inpatient care.

We claim:

1. A computer-implemented web-based, analytic system for physician-directed reductions in clinical variation comprising:
a) searching one or more computer databases and one or more computer network memory storage components for medical information from Severity Of Illness (SOI) data;
b) compiling and aggregating said clinical data gathered from Severity Of Illness (SOI) data, wherein said aggregation of data includes the use of a Sherlock computer program sub-system and memory which aggregates and targets patients outcomes by physician, SOI level, individual hospital, hospitals' and clinical services;
c) using the aggregated and compiled clinical data along with patient-level severity adjusted data calculated using the Acuity Index Method or other Risk-Adjustment method, and displaying two-standard deviation patient distributions for three years using Sherlock data;
d) wherein said Sherlock computer sub-system's aggregated and compiled data is further analyzed by a Watson based computer sub-system to calculate the variation between the two patient cohorts; and
e) further wherein the Watson based computer sub-system further aggregates and compiles hospital Revenue Code Rollup for all resource consumption types as recorded in the hospital's charge master by individual hospital departments.

2. The computer-implemented web-based, analytic system for physician-directed reductions in clinical variation, according to claim 1, wherein said searching one or more computer databases and one or more computer network memory storage components for medical information from Severity Of Illness (SOI) data includes searching public data available from public databases, including MedPAR data, federal data, state data, and insurance company data.

3. The computer-implemented web-based, analytic system for physician-directed reductions in clinical variation, according to claim 1, wherein said searching one or more computer databases and one or more computer network memory storage components for medical information from Severity Of Illness (SOI) data includes searching in-house data from clinics, doctor's offices and hospitals including hospitalized patients' charts data, hospital medical records data, physicians' office data, and hospital clinical service databases from hospital departments, laboratories, pharmacies, and diagnostic departments.

4. The computer-implemented web-based, analytic system for physician-directed reductions in clinical variation, according to claim 1, wherein said compiling and aggregating said clinical data gathered from Severity Of Illness (SOI) data includes compiling data from public data available from public databases, including MedPAR data, federal data, state data, and insurance company data.

5. The computer-implemented web-based, analytic system for physician-directed reductions in clinical variation, according to claim 1, wherein said compiling and aggregating said clinical data gathered from Severity Of Illness (SOI) data includes compiling data from searching in-house data from clinics, doctor's offices and hospitals including hospitalized patients' charts data, hospital medical records data, physicians' office data, and hospital clinical service databases from hospital departments, laboratories, pharmacies, and diagnostic departments.

6. The computer-implemented web-based, analytic system for physician-directed reductions in clinical variation, according to claim 1, wherein said aggregation of data includes the use of a Sherlock computer program sub-system and memory which aggregates and targets patients outcomes by condition type including diagnoses and procedures at a ICD9-CM or equivalent or greater level, contained in the hospitals' Uniform Hospital Discharge Data Set, and revenue code level and resource utilization levels.

7. The computer-implemented web-based, analytic system for physician-directed reductions in clinical variation, according to claim 1, wherein said using the aggregated and compiled data along with patient-level severity adjusted data calculated using the Acuity Index Method or other Severity of Illness method, and displaying two-standard deviation patient distributions for three years using Sherlock data, includes identifying two patient cohorts within a two standard deviation of one cohort with fewer resource consumptions than internal cost norms and short Lengths Of Stay (LOS) and the other cohort with higher cost outcomes and longer LOS than the internal norms.

8. The computer-implemented web-based, analytic system for physician-directed reductions in clinical variation, according to claim 1, wherein said Sherlock computer sub-system's aggregated and compiled data which is further analyzed by a Watson based computer sub-system to calculate the variation between the two patient cohorts within the two standard deviation level is determined by a percent difference for: patients outcomes by physician, SOI level, hospitals' clinical services, condition type, diagnoses and procedures at a ICD9-CM or equivalent or greater level, contained in the hospitals Uniform Hospital Discharge Data Set, and revenue code level and resource utilization levels.

9. The computer-implemented web-based, analytic system for physician-directed reductions in clinical variation, according to claim 1, wherein said Watson based computer sub-system further aggregates and compiles hospital Revenue Code Rollup for all resource consumption types as recorded in the hospital's charge master by individual hospital departments and by physician, SOI level, hospitals' clinical services, condition type, and diagnoses and procedures at a ICD9-CM or equivalent or greater level.

10. The computer-implemented web-based, analytic system for physician-directed reductions in clinical variation, according to claim 1, wherein said Watson based computer sub-system further calculates variations by percentage differences between all resource types as recorded in hospital's charge master by individual hospital departments, by physician, SOI level, hospitals' clinical services, condition type and diagnoses and procedures at a ICD9-CM or equivalent or greater level.

11. A method for making a computer-implemented web-based system for physician-directed reductions in clinical variation analysis, comprising the steps of:
a) providing for searching one or more computer databases and one or more computer network memory storage components for medical information from Severity Of Illness (SOI) data,
b) compiling and aggregating said clinical data gathered from SOI data, wherein said aggregation of data includes the use of a Sherlock computer program sub-system and memory which aggregates and targets patients outcomes by physician, SOI level, individual hospital, hospitals' and clinical services;
c) using the aggregated and compiled data along with patient-level severity adjusted data calculated using the Acuity Index Method or other Risk-Adjustment method, and displaying two-standard deviation patient distributions for three years using Sherlock data;
d) wherein said Sherlock computer sub-system's aggregated and compiled data is further analyzed by a Watson based computer sub-system to calculate the variation between the two patient cohorts; and
e) further wherein the Watson based computer sub-system further aggregates and compiles hospital Revenue Code Rollup for all resource consumption types as recorded in the hospital's charge master by individual hospital departments.

12. The method for making a computer-implemented web-based, analytic system for physician-directed reductions in clinical variation, according to claim 11, wherein said searching one or more computer databases and one or more computer network memory storage components for medical information from Severity Of Illness (SOI) data includes searching public data available from public databases, including MedPAR data, federal data, state data, and insurance company data.

13. The method for making a computer-implemented web-based, analytic system for physician-directed reductions in clinical variation, according to claim 11, wherein said searching one or more computer databases and one or more computer network memory storage components for medical information from Severity Of Illness (SOI) data includes searching in-house data from clinics, doctor's offices and hospitals including hospitalized patients' charts data, hospital medical records data, physicians' office data, and hospital clinical service databases from hospital departments, laboratories, pharmacies, and diagnostic departments.

14. The method for making a computer-implemented web-based, analytic system for physician-directed reductions in clinical variation, according to claim 11, wherein said compiling and aggregating said clinical data gathered from Severity Of Illness (SOI) data includes compiling data from public data available from public databases, including MedPAR data, federal data, state data, and insurance company data.

15. The method for making a computer-implemented web-based, analytic system for physician-directed reductions in clinical variation, according to claim 11, wherein said compiling and aggregating said clinical data gathered from Severity Of Illness (SOI) data includes compiling data from searching in-house data from clinics, doctor's offices and hospitals including hospitalized patients' charts data, hospital medical records data, physicians' office data, and hospital clinical service databases from hospital departments, laboratories, pharmacies, and diagnostic departments.

16. The method for making a computer-implemented web-based, analytic system for physician-directed reductions in clinical variation, according to claim 11, wherein said aggregation of data includes the use of a Sherlock computer program sub-system and memory which aggregates and targets patients outcomes by condition type including diagnoses and procedures at a ICD9-CM or equivalent or greater level, contained in the hospitals' Uniform Hospital Discharge Data Set, and revenue code level and resource utilization levels.

17. The method for making a computer-implemented web-based, analytic system for physician-directed reductions in clinical variation, according to claim 11, wherein said using the aggregated and compiled data along with patient-level severity adjusted data calculated using the Acuity Index Method, and displaying two-standard deviation patient distributions for three years using Sherlock data, includes identifying two patient cohorts within a two standard deviation of one cohort with fewer resource consumptions than internal cost norms and short Lengths Of Stay (LOS) and the other cohort with higher cost outcomes and longer LOS than the internal norms.

18. The method for making a computer-implemented web-based, analytic system for physician-directed reductions in clinical variation, according to claim 11, wherein said Sherlock computer sub-system's aggregated and compiled data which is further analyzed by a Watson based computer sub-system to calculate the variation between the two patient cohorts within the two standard deviation level is determined by a percent difference for: patients outcomes by physician, SOI level, hospitals' clinical services, condition type, diagnoses and procedures at a ICD9-CM or equivalent or greater level, contained in the hospitals Uniform Hospital Discharge Data Set, and revenue code level and resource utilization levels.

19. The method for making a computer-implemented web-based, analytic system for physician-directed reductions in clinical variation, according to claim 11, wherein said Watson based computer sub-system further aggregates and compiles hospital Revenue Code Rollup for all resource consumption types as recorded in the hospital's charge master by individual hospital departments and by physician, SOI level, hospitals' clinical services, condition type, and diagnoses and procedures at a ICD9-CM or equivalent or greater level.

20. The method for making a computer-implemented web-based, analytic system for physician-directed reductions in clinical variation, according to claim 11, wherein said Watson based computer sub-system further calculates variations by percentage differences between all resource types as recorded in hospital's charge master by individual hospital departments, by physician, SOI level, hospitals' clinical services, condition type and diagnoses and procedures at a ICD9-CM or equivalent or greater level.
